(19) United States
(12) Patent Application Publication
(10) Pub. No.: US 2018/0189875 A1
(43) Pub. Date: Jul. 5, 2018

(54) ELECTRONIC CALCULATOR FOR REAL TIME OPTIMISATION, SEARCHING, AND EXTRAPOLATING MULTIPLE SCENARIOS OF POST-RETIREMENT CASH FLOW WITH INTERTEMPORAL SETTINGS, AND SYSTEM AND METHOD THEREOF

(71) Applicant: SALPRO PTY LTD, Milsons Point (AU)

(72) Inventors: Edward Charles DE SALIS, Rose Bay (AU); James Benedict CLARIDGE, North Sydney (AU)

(21) Appl. No.: 15/397,232

(22) Filed: Jan. 3, 2017

(51) Int. Cl. G06Q 40/04; G06Q 40/06

(52) U.S. Cl. CPC G06Q 40/04; G06Q 40/06

(57) ABSTRACT

An electronic calculator for carrying out a process of calculating an optimal cash flow for post-retirement stage, the process comprising the steps of: receiving personal financial data from a user; connecting to a database and retrieving simulation data; wherein the simulation data is integrated with the personal financial data to generate the current and future assets and cash flow data; generating a set of assets for allocation; and connecting to a remote server, and forwarding at least part of current and future assets and cash flow data, simulation data, and the set of assets for allocations to carry out a selected risk percentile from the personal financial data.

### FIELD OF THE INVENTION

The invention relates to retirement portfolio simulations, calculators and processes/methods thereof. More particularly, the present invention may relate to an electronic calculator for real-time searching and extrapolating multiple scenarios of post-retirement cash flow with intertemporal setting, and system and method thereof.

### BACKGROUND OF THE INVENTION

Calculating post-retirement cash flow and gross returns is a complex task. There are numerous variables which can affect the results, including retirement income adequacy, investment strategy, contributions strategy, legacy strategy, transition to retirement strategy, and insurance. These variables may change on a daily basis. In the calculation, it also requires extrapolating historical data of different aspect of local and global economy.

A typical traditional method is to recommend that a retiree annually spends a fixed, real amount equal to 4% of his initial wealth, and rebalance the remainder of his money in a 60%-40% mix of stocks and bonds throughout a 30-year retirement period. Confidence in the plan is often expressed as the probability of its success, e.g., in nine of ten scenarios, the retiree will sustain his or her spending. Modifications to this basic example include changing the amount to withdraw, the length of the plan, the portfolio mix, the rebalancing frequency, or the confidence level.

Traditionally, financial planners have estimated a particular retiree's annual spending budget using a mortgage calculator, an estimate of the average rate of return on the retiree's investments, and the retiree's horizon—the number of years that a retiree's investments had to support his spending.

These mortgage calculators are not designed to cater for retirement planning. In particular, it does not really take into consideration of the different certainties in a particular strategy. Further, to include a cost of living increase, the planner would adjust the average nominal investment return downwards by an estimate of the average inflation rate and compute the real spending. Traditional models for these types of calculators fail to account for uncertainty and assume 50/50 static uncertainty model. This is a fundamental failure of these systems, as users may want to adjust the level of uncertainty to improve the overall accuracy of the results. Traditional models fail to calculate for variable or user determined levels of uncertainty.

When estimates of success rates are based on a small number of scenarios, they are typically prone to estimation error. This is particularly true for estimates that use overlapping particular historical scenarios or events. Considering the amount of variables and historic data involved, it is not currently possible to carry out real-time calculations in excel or desktop computing.

A previous example of a calculator is described in the “Retirement Income Calculator” (T. Rowe Price 2008b), where the monthly returns are assumed to be jointly normal. The calculator automatically accounts for minimum required distributions after age 70.5, attempts to decrease equity exposure every five years, and yearly inflates withdrawals by 3%. For a single retiree starting retirement at age 65, having a 30-year horizon, beginning with a $1 million portfolio, investing initially in a 60% equity mix (“portfolio E”), and withdrawing $3.3K per month, the withdrawal rate is 3.96%, and the calculator predicts a 90% success rate. However, there is no interaction for the user to adjust different certainty of the success rate. This prior art calculator also does not provide the optimal strategy in a particular scenario.

U.S. Pat. No. 8,370,243 discloses a simulator to help individuals on financial planning and investment issues. In particular, this prior art aids in the evaluation of the relative risks and rewards of a mixed portfolio compared to a safer alternative and to choose an asset allocation. This simulator models the baseline portfolio as being entirely allocated to low-risk asset, the mixed portfolio as having assets that are subdivided between the low-risk assets and comparatively more volatile assets, and retirement budgets drawn from the mixed portfolio with computer-performed computations that constrain the size of each interval's retirement budget as a function of a remaining balance of the mixed portfolio. The simulator receives at least one simulated portfolio performance outcome, generated by computer-performed computations that are a function of the modelled retirement budgets drawn from the mixed portfolio; receives a baseline portfolio performance outcome that is a function of computer-performed computations of a baseline retirement budget drawn from the baseline portfolio, to compare with the simulated portfolio performance outcome; and publishes, on a graphical user interface, both the simulated portfolio performance outcome and the baseline portfolio performance outcome in proximity to each other to facilitate comparative visualization of the performance outcomes.

US Patent Application No. 20150178843 discloses a method for interactive retirement planning includes displaying a landing page that includes a topic dashboard on a mobile device. The topic dashboard depicts topic identifiers, and each topic identifier is an element of a retirement plan. A first user input identifying a selected topic identifier within the topic identifiers is received. A topic information page relating to the selected topic identifier is selected. The topic information page includes interactive content relating to the element of the retirement plan that corresponds with the selected topic identifier. The topic information page including the interactive content relating to the element of the retirement plan is displayed to the user on the mobile device. In response to receiving a second user input, the interactive content related to the element of the retirement plan that is displayed to the user is modified to reflect a user preference corresponding with the second user input.

The present invention is substantially different in at least one or more design elements from the prior art, and consequently, it is clear that there is a need in the art for a portable apparatus for manipulating and aligning articles in one or more dimensions within a confined space.

Previous attempts at these types of calculator have failed to allow for interaction by the user to adjust different certainty of the success rate. The prior art also does not provide the optimal strategy in a particular scenario.

Any discussion of the prior art throughout the specification should in no way be considered as an admission that such prior art is widely known or forms part of common general knowledge in the field.

### SUMMARY OF THE INVENTION

It is, therefore, an object of the present invention to provide an electronic calculator for real-time searching and extrapolating multiple scenarios of post-retirement cash flow with intertemporal settings, system and method thereof and has heretofore not been utilized.

Other objects and advantages will become apparent when taken into consideration with the following specification and drawings.

It is also an object of the present invention to overcome or ameliorate at least one of the disadvantages of the prior art, or to provide a useful alternative.

Preferably, a first aspect of the present invention may provide for an electronic calculator for carrying out a process of calculating an optimal cash flow for post-retirement stage, the process comprising the steps of: receiving personal financial data from a user; connecting to a database and retrieving simulation data; wherein the simulation data is integrated with the personal financial data to generate the current and future assets and cash flow data; generating a set of assets for allocation; connecting to a remote server, and forwarding at least part of current and future assets and cash flow data, simulation data, and the set of assets for allocations to carry out the steps of:

for each iteration of an asset in the set of assets for allocation, carry out the following simulations to generate a retirement income based on an associated risk percentile:

(i) calculate minimum drawdown, age pension and tax for each year;

(ii) calculating assets and liabilities at the end of a year, and

(iii) determine whether the net assets is less than legacy and age is greater than a target age

retrieving a selected risk percentile from the personal financial data;

sorting assets allocation based on the retirement income;

selecting optimal asset allocation; and

generating and displaying a report with the optimal asset allocation.

Preferably, the tax for each year comprises any one or more of a tax on non-super investment income, and gross income tax.

More preferably, the tax on non-super investment income is derived with the following algorithm:

```
CG(t) = OthAss(t − 1)
      × (QthEQ × (EQRet(t) − EQDiv) + OthOE
      × (OERet(t) − OEDiv) + OthPR × (PRRet(t) − PRDiv))
DivInc(t) = OthAss(t − 1) × OthEQ × EQDiv
$FC ( t ) = DivInc ( t ) \times FrankProp \times \frac{CorpTax}{( 1 - CorpTax )}$
$TaxInvInc ( t ) = OthAss ( t - 1 ) \times OthRet ( t ) + FC ( t ) - \frac{CG ( t )}{2} - OthLiab ( t \\ - 1 ) \times LiabRet ( t )$
If Age(t) < RetAge then
  $InvTax ( t ) = ( Tax ( \frac{TaxInvInc ( t )}{AWEInd ( t )} + Income ) - Tax ( Income ) ) \\ \times AWEInd ( t )$
Else
  $InvTax ( t ) = Tax ( \frac{TaxInvInc ( t )}{AWEInd ( t )} ) \times AWEInd ( t )$
Endif
If OthAss(t − 1) × OthRet(t) <> 0 then
  $InvTax ( t ) = Tax ( \frac{TaxInvInc ( t )}{AWEInd ( t )} ) \times AWEInd ( t )$
  $OthTax ( t ) = \frac{tnvTax ( t ) - FC ( t )}{OthAss ( t - 1 ) \times OthRet ( t )}$
Else
  OthTax(t) = 0
Endif
```

The gross income tax as may be derived with the following algorithm:

Tax = 0
For i = 1 To 5

Tax = Tax

+ Max(Min(GrossInc − Thresh(i),
Thresh(i + 1) − Thresh(i)) × TRate(i), 0)

Next i
Tax = Tax + Medicare × GrossInc

the minimum drawdown may be derived with the following algorithm:

If Age(t) > RetAge And Age(t) > PresAge Then

MinPensionAmt(t) = SupAss(t − 1) × MinPension(Age(t))

Else

MinPensionAmt(t) = 0

Endif

The age pension may be derived with the following algorithm:

```
$DeemAss ( t ) = \frac{SupAss ( t - 1 ) + OtherAss ( t - 1 ) - Liab ( t - 1 )}{CPIInd ( t - 1 )}$
If Age(t) < AgePensionAge Then
  AgePensionAmt(t) = 0
ElseIf (Age(t) < RetAgeAndIncome
            > IncThreshx26 + WorkBonus)or(DeemAss(t)
            > AssThreshMax) Then
  AgePensionAmt(t) = 0
Else
  DeemInc(t) = DeemAss(t)xDeemRate(1)
            +Max(DeemAss − DeemThresh, 0)x(DeemRate(2)
            − DeemRate(1))
  $TotalInc ( t ) = \frac{DeemInc ( t ) + Max ( Income - WorkBonus , 0 )}{26}$
  IncTestPension(t) = (TotalInc(t) − IncThresh) × IncReduction
  AssTestPension(t) = (DeemAss(t) − AssThreshMin) × AssReduction
  AgePensionAmt(t)
            = CPIInd(t − 1)
            × Max ((AgePension
            − Max(IncTestPension(t) , AssTestPension(t), 0)), 0) × 26
Endif
```

The assets and liabilities at the end of year may be derived with the following algorithm:

```
Liab(t) = Liab(t − 1) × (1 + LiabRet(t)) + OthLiab(t − 1) × LiabRet(t)
            + (CFOutAndP(t) − MinPensionAmt(t) − AgePensionAmt(t)
            − OthCFIn(t)) × (1 + LiabRet(t))^{0.5}
SupLiab(t) = SupLiab(t − 1)
OthLiab(t) = OthLiab(t − 1)
HomeLiab(t) = HomeLiab(t − 1)
OthAss(t) = OthAss(t − 1) × (1 + OthRet(t) × (1 − OthTax(t)))
SupAss(i, j) = SupAss(t) × (1 + SupRet(t))
            + (SupCFIn(t) − MinPensionAmt(t)) × (1 + SupRet(t))^{0.5}
            − SupLiab(t − 1) × LiabRet(t) × (1 − SupInvTax)
HomeAss(t) = HomeAss(0) × AWEInd(t)
If Age(t) ≥ RetAge Then
  Liab(t) = Liab(t) + HomeLiab(t)
  HomeLiab(t) = 0
  SupAss(t) = SupAss(t) − SupLiab(t)
  SupLiab(t) = 0
EndIf
If OthAss(t) < OthLiab(t)Then
  Liab(t) = Liab(t) + (OthLiab(t) − OthAss(t))
  OthAss(t) = 0
  OthLiab(t) = 0
ElseIf OthAss(t) < Liab(t) Then
  Liab(t) = Liab(t) − OthAss(t)
  OthAss(t) = 0
Else
  OthAss(t) =OthAss(t) − Liab(t)
  Liab(t) = 0
EndIf
If (Age(t) < PresAge or (Age(t) ≥ PresAge and
      Age(t) < RetAge and Age(t) < FullAccessAge)) and Age(t)
            < TargetSFAge Then
If HomeAss(t) < Liab(t) Then
      ShortfallPreRet = ShortfallPreRet + 1
EndIf
Else
If SupAss(t) < Liab(t) Then
      Liab(t) = Liab(t) − SupAss(t)
      SupAss(t) = 0
Else
    SupAss(t) = SupAss(t) − Liab(t)
    Liab(t) = 0
EndIf
EndIf
TotAss(t) = OthAss(t) − OthLiab(t) + SupAss(t) − SupLiab(t) + HomeAss(t)
            − HomeLiab(t) − Liab(t)
$If \frac{TotAss ( t )}{CPIInd ( t )} > TargetLegacy Then$
        ShortfallAge = Age(t)
        ShortfallAssets = TotAss(t)/CPIInd(t)
EndIf
$If Age ( t ) = RetAge Then ShortfallAssetsRetAge = \frac{TotAss ( t )}{CPIInd ( t )}$
$If Age ( t ) = TargetSFAge Then ShortfallAssetsTargetSFAge = \frac{TotAss ( t )}{CPIInd ( t )}$
```

Preferably, the report comprises user input interface for a user to adjust the personal financial data. The preferred report may be adapted to display all the assets allocation by the retirement income.

The preferred report may further comprise a graph showing a set of simulated investment strategies according to risks and retirement income.

The preferred electronic calculator may also further comprise a display and an input device. The input device may be a touch screen. The preferred electronic may further comprise a communication module for connecting to a network through a network protocol such as Ethernet, Wi-Fi™ or Blue Tooth™. A connection to the remote server may also be carried out through an application programming interface.

The preferred application programming interface is provided through Amazon Web Services™.

The electronic calculator may also comprise a handheld sized body.

A second aspect of the present invention may part or all of the previous first aspect and may also additionally comprise: a computer terminal having one or more central processing units, and memory unit; an I/O interface connecting to one or more input device, and output devices, a network interface module.

A third aspect of the present invention may comprise a computing process comprising the steps of: receiving personal financial data from a user; connecting to a database and retrieving simulation data; wherein the simulation data is integrated with the personal financial data to set up the current and future assets and cash flow data; generating a set of assets for allocation; connecting to a remote server, and forwarding at least part of current and future assets and cash flow data, simulation data, and the set of assets for allocations to carry out the steps of:
for each iteration of an asset in the set of assets for allocation, carry out the following simulations to generate a retirement income and risk percentile associated:
(i) calculate minimum drawdown, age pension and tax for each year;
(ii) calculating assets and liabilities at the end of a year, and
(iii) determine whether the net assets is less than legacy and age is greater than a target age

retrieving a selected risk percentile from the personal financial data;

sorting assets allocation by the retirement income;

selecting optimal asset allocation; and

generating and displaying a report with the optimal asset allocation.

Preferably, the machine codes for carrying out the process of the third aspect on an electronic calculator. Preferably, An electronic, electromagnetic or optic media carrying the machine codes for carrying out the process of claim 18 on a computer terminal.

### BRIEF DESCRIPTION OF THE FIGURES

FIG. 1 is a first use case diagram of a first preferred embodiment of the present invention;

FIG. 2 is a second use case diagram of a second embodiment of the present invention;

FIG. 3 is a flow diagram of an embodiment of the present invention;

FIG. 4 is a first interface design for an electronic calculator of an embodiment of the present invention;

FIG. 5 is a second interface design for an electronic calculator of an embodiment of the present invention;

FIG. 6 is a third interface design for an electronic calculator of an embodiment of the present invention;

FIG. 7 is a fourth interface design for an electronic calculator of an embodiment of the present invention;

FIG. 8 is a fifth interface design for an electronic calculator of an embodiment of the present invention;

FIG. 9 is a sixth interface design for an electronic calculator of an embodiment of the present invention;

FIG. 10 is a seventh interface design for an electronic calculator of an embodiment of the present invention;

FIG. 11 is an eighth interface design for an electronic calculator of an embodiment of the present invention;

FIG. 12 is a ninth interface design for an electronic calculator of an embodiment of the present invention;

FIGS. 13 and 13A are a tenth interface design for an electronic calculator of an embodiment of the present invention;

FIG. 14 is an eleventh interface design for an electronic calculator of an embodiment of the present invention;

FIG. 15 is a twelfth interface design for an electronic calculator of an embodiment of the present invention;

FIG. 16 is a thirteenth interface design for an electronic calculator of an embodiment of the present invention;

FIG. 17 is a fourteenth interface design for an electronic calculator of an embodiment of the present invention;

FIG. 18 is a fifteenth interface design for an electronic calculator of an embodiment of the present invention; and

FIG. 19 is a sixteenth interface design for an electronic calculator of an embodiment of the present invention;

FIG. 20 is a sixteenth interface design for an electronic calculator of an embodiment of the present invention;

FIG. 21 is a seventeenth interface design for an electronic calculator of an embodiment of the present invention;

FIG. 22 is an eighteenth interface design for an electronic calculator of an embodiment of the present invention;

FIG. 23 is a nineteenth interface design for an electronic calculator of an embodiment of the present invention;

FIG. 24 is a twentieth interface design for an electronic calculator of an embodiment of the present invention;

FIG. 25 is a twenty-first interface design for an electronic calculator of an embodiment of the present invention;

FIG. 26 is a twenty-second interface design for an electronic calculator of an embodiment of the present invention;

FIG. 27 is a flow chart of a first application of the electronic calculator of an embodiment of the present invention;

FIG. 28 is a flow chart of a second application of the electronic calculator of an embodiment of the present invention;

FIG. 29 is a flow chart of a third application of the electronic calculator of an embodiment of the present invention;

### DETAILED DESCRIPTION

In a first embodiment of the present invention, there is provided an electronic calculator for real-time optimisation, searching, and extrapolating multiple scenarios of post-retirement cash flow with intertemporal settings. Preferably, the calculator may be adjusted by the user to allow for variable or user-selected levels of uncertainty to improve or decrease the reliability of the forecasted outcomes.

The electronic calculator of an embodiment of the present invention comprises a handle device having an input interface for receiving user input and an output interface for displaying the output. Also, the electronic calculator communication module to connect to a network such as a LAN, WAN or Internet through a wire or wireless connection such as Ethernet, Wi-Fi™, Bluetooth™.

The purpose of the electronic calculator of an embodiment of the present invention is to provide simplified device or interface for the complex process to project, for each simulation, the future cash flows, assets and liabilities of the client so that we can present to them the maximum outcomes for their retirement at any given confidence level and show them which asset allocation produces that maximum outcome. The retirement outcomes include:
retirement age,
retirement income,
legacy (amount of assets to be left behind by a client at shortfall age),
certainty of the strategy (confidence); and
shortfall age (age at which retirement assets fall to legacy)

For example, putting into a sentence, the calculator simplifies the process to answer what might read as “With 75% confidence you can have $80,000 annual income from retirement at age 65 up to age 90 and leave $500,000 legacy” (all dollar amounts in today's values). The user may be able to specify all but one of the variables e.g. if they specify confidence level, retirement age, retirement income and legacy then the algorithm will show them at what age their funds are exhausted (or reach their target legacy, if greater than zero).

These variables are chosen so that the joint probability distribution of the processes reflects the average values, variances, and correlations commonly observed. An unlimited supply of scenarios can be numerically generated from these models, and then statistics, such as the success rate, can be computed using Monte Carlo methods.

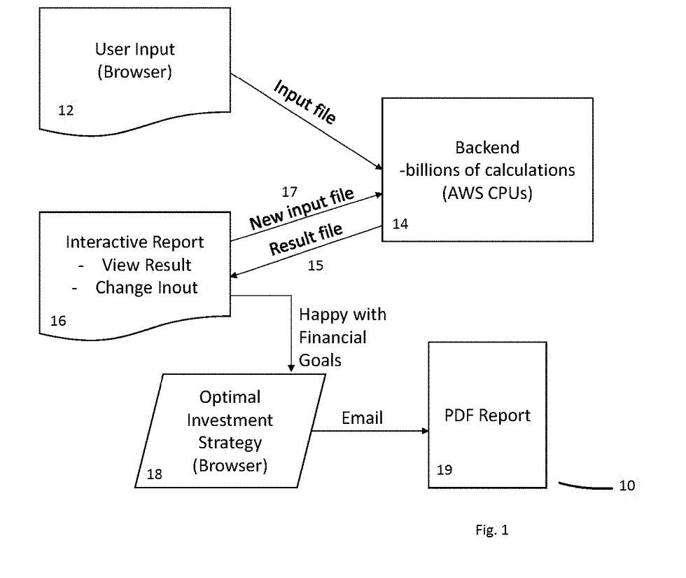

Referring to FIG. 1, a use case of an embodiment of an electronic calculator 10 for real-time optimisation, searching and extrapolating multiple scenarios of post-retirement cash flow with intertemporal settings of the present invention is shown. The calculator 10 provides an interface 12 for a user to input data. In one preferred embodiment, the interface is a keypad or keyboard for the user to physically key in the data although other input devices may be used. In another embodiment, the interface is a touch screen which presents a virtual keyboard or other graphical user interface components such as option box, radio buttons, etc. for the user to input data. In another embodiment, the interface is a browser which provides different graphical user interfaces for the user to input the data.

Once the calculator 10 received the input data from the user, the calculator will send the input file 13 to a server of the backend system 14. In one embodiment, the backend system comprises one or more servers, each of which will have one or more processors (CPUs or GPUs) or virtual processors for performing parallel computations or parallel processing. In another embodiment, the backend system 14 is connected to a cloud computing service which can carry out parallel computing. In another embodiment, the backend system 14 utilises the Amazon Web Services™ which provide a series of Graphical Processor Units (GPUs) to carry out parallel computing through CUDA or OpenCL. The backend system 14 is adapted to retrieve historic economic data, investment and asset data from a database, and carry out billions of calculation for different simulated scenarios.

After the backend system 14 finished billions of calculations for different simulated scenarios, the backend system will send the results data 15 back to the calculator 10. The calculator 10 analyses the results and generates an interactive report 16. In one embodiment, the calculator 10 comprises a display for displaying the interactive report to a user. In another embodiment, the calculator 10 is connected to an output device such as a projector or monitor to display the interactive report. In another embodiment, the calculator 10 comprises a browser which displays the interactive report through the browser.

Based on the results data 15 of the interactive report, a user may adjust or change the input data or parameters through the interactive report. After the user makes changes to the data on the interactive reports, the calculator 10 will send the new input data 17 to the backend system 14 for further processing and return a new set of results data to generate a new interactive report.

In every iteration of the results data and interactive report, there is provided a set of investment strategy to a user based on the percentage of certainty of attaining the goal. The user may choose from less than 50% to up to 99% certainty. Within the domain of investment strategy provided in the results data 15 or interactive report, there is at least one or more optimal investment strategy 18 that provide the user with the highest return. We note that traditional prior art models of forecasting are generally limited to fixed levels of uncertainty which are typically 50% or less.

After viewing the interactive report, the user may request the interactive report to be emailed to him or her in portable document format 19.

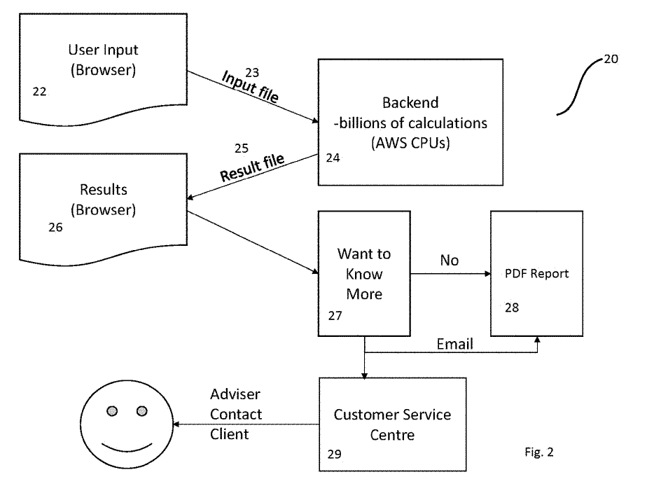

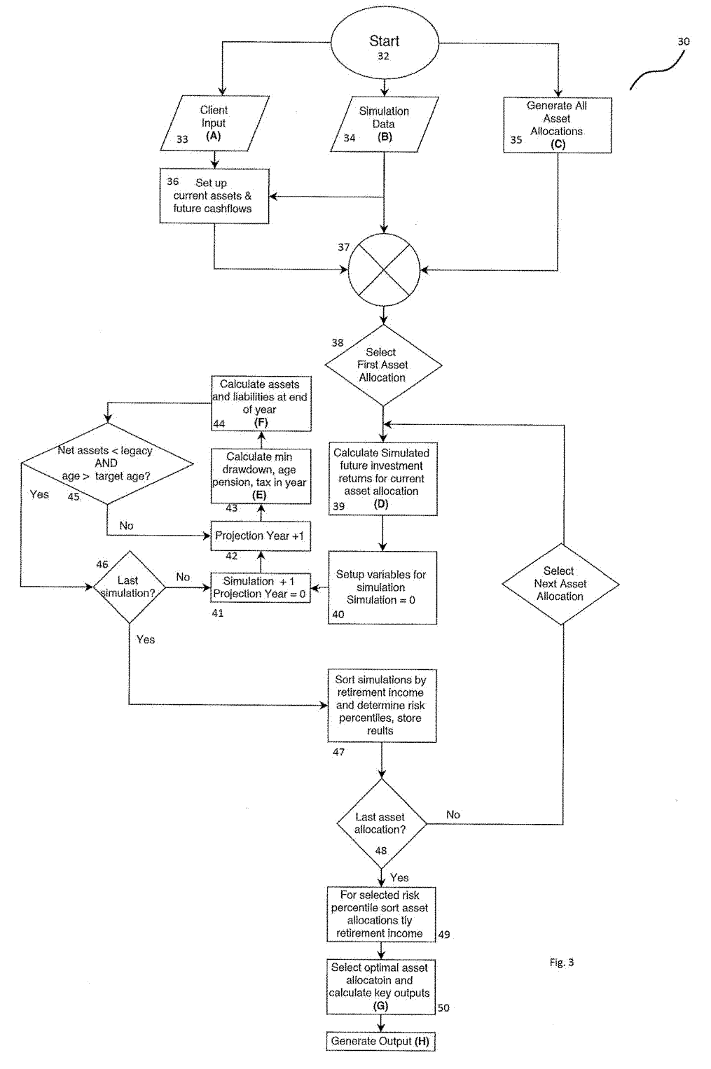

Referring to FIG. 2, a second use case of an embodiment of an electronic calculator for real-time optimisation, searching and extrapolating multiple scenarios of post-retirement cash flow with intertemporal settings of the present invention is shown. The calculation 20 first provide an interface 22 for a user to input data

Once the calculation of the present invention received the input data from the user, the calculation will send the input file 23 to a server of the backend system 24. The backend system 24 is adapted to retrieve historic economic data, investment and asset data from a database, and carry out billions of calculation for different simulated scenarios.

After the backend system 24 finished billions of calculation for different simulated scenarios, the backend system will send the results data 25 back to the calculator 20. The calculator 20 analyses the results and generate an introductory report 26. In one embodiment, the calculator 20 comprises a display for displaying the introductory report to a user

With the introductory report, the calculator will prompt 27 to ask the user whether a detailed report is required.

In every iteration of the results data and interactive report, there is provided a set of investment strategy to a user based on the percentage of certainty of attaining the goal. The user may choose a selected level of certainty from between 50% to up to 99% certainty. Within the domain of investment strategy provided in the results data or interactive report, there is at least one or more optimal investment strategy that provides the user with the highest return. If the user answers negative, the calculator 20 will generate a pdf format of the introductory report 28 to the user. In the event that the user answers positive, the calculator 20 will send an email to a professional such as customer service system to prompt an adviser to contact the user as in step 29.

FIG. 3 shows a flow diagram describing the process of the calculator of the present invention. Reference is now made to the FIG. 3. The system 30 starts the process in step 32. In step 32, the electronic calculator 30 forks out three or more threads or processes: the client input step 33, simulation data step 34, and generation of all asset allocation step 35. The client input step 33 involves displaying a series of Graphical User Interface (GUI) and presenting a series of questions for a user to answer. The retrieving of simulation data step 34

The simulation data step 34 involves the simulation of future investment returns for each asset class and other economic variables.

Simulations of future investment returns and other economic variables are generated from autoregressive models applied to historic time series data (monthly) and allow for correlations. The time series data are sourced from central banks and other relevant sources. They include total returns for equities and price movements for properties (to which an assumed rental yield is added).

In designing the system, effect is made to ensure: (i) the appropriateness of the time series data—in particular any transformations of the raw data (whether % returns are modelled, changes in returns, log returns etc.); (ii) the use of autoregressive models for simulating the future; and (iii) any considerations or adjustments that should be made to allow for a future that is different to the past.

In one embodiment, the models for investment returns and other economic variables are determined using parameters of the risk involved (@Risk). It is intended that they should remain as simple as possible whilst still remain fit for purpose. The simulations will be updated at least monthly as new data becomes available. It is proposed that 2000 simulations are sufficient to provide the confidence levels required.

Future investment returns are simulated for each of the following five asset classes and other economic variables:
Cash
Fixed interest
Property (direct)
Australian equities
Overseas equities
Average Weekly Earnings
Consumer Price Index
USD/AUD exchange rate

Future investment returns are simulated for each of the following five asset classes and other economic variables:
Cash
Fixed interest
Property (direct)
Australian equities
Overseas equities
Average Weekly Earnings
Consumer Price Index
USD/AUD exchange rate

The following table describes some preferred data, sources, and availabilities for use with the modelling of the embodiments:

| Variable | Data | Source | Available History |
|---|---|---|---|
| Cash | 3 month term | RBA | Monthly, December |
| | deposit rates | | 1991 to September |
| | | | 2015 |
| Fixed | 5 yr Govt | RBA | Monthly, January |
| Interest | Bonds | | 1972 to September |
| | | | 2015 |
| Properly | Established | ABS | Quarterly, March |
| (direct) | House Price | | 2002 to June 2015 |
| | Index Average | | Quarterly, June |
| | 8 capital cities | | 1986 to June 2005 |
| Australian | ASX200 Total | marketindex.com.au | Monthly, December |
| equities | Return | | 1979 to September |
| | | | 2015 |
| Overseas | DJIA Total | Djaverages.com | Monthly, September |
| equities | Return | | 1987 to September |
| | | | 2015 |
| Average | All persons, | ABS | Quarterly, November |
| Weekly | all earnings | | 1983 to May 2015 |
| Earnings | | | |
| Consumer | Average 8 | ABS | Quarterly, September |
| Price | capital cities | | 1948 to June 2015 |
| Index | | | |
| USD/ | Exchange rate | RBA | Monthly, July 1969 |
| AUD | | | to September 2015 |

Data that was available less frequently than monthly was interpolated and extrapolated as required (linear assumption). For a consistent time series, monthly data from September 1987 (just prior to the October 1987 crash) was used to fit the functions and correlation matrix for all variables.

Fitting of the functions and parameters was done using @Risk time-series batch fit, which fits all functions simultaneously and includes the correlation matrix. Transformations of the raw data were made before @Risk was applied.

In one embodiment, the data undergo the following transformations, functions and parameters.

| Variable | Transformation | Function | Parameters |
|---|---|---|---|
| Cash | Ln(Cash Rate) | BMMR | μ = −6.09, σ = 0.076 |
| Fixed | Ln(Bond Yield) − | AR2 | μ = 0.246, σ = 0.082 |
| Interest | Ln(Cash Rate) | | |
| Property | Ln(Index(t)/ | AR2 | μ = 0.0034, σ = 0.0057 |
| (direct) | Index(t − 1)) − | | |
| | Ln(CPI) | | |
| Australian | Ln(Index(t)/ | BMMR | μ = 0.005, σ = 0.114 |
| equities | Index(t − 1)) − | | |
| | Ln(CPI) | | |
| Overseas | Ln(Index(t)/ | BMMR | μ = 0.006, σ = 0.113 |
| equities | Index(t − 1)) − | | |
| | Ln(USA CPI) | | |
| Average | Ln(AWE(t)/ | AR2 | μ = 0.0007, σ = 0.0024 |
| Weekly | AWE(t − 1)) − | | |
| Earnings | Ln(CPI) | | |
| Consumer | Ln(Index(t)/ | AR2 | μ = 0.0025, σ = 0.0019 |
| Price | Index(t − 1)) | | |
| Index | | | |
| USD/AUD | Ln(Exchange | AR2 | μ = −0.282, σ = 0.030 |
| | Rate) | | |

Regarding the above transformation, the cash rate is converted from annual rate to effective monthly rate using the formula

$${( 1 + \frac{i}{100} )}^{1 / 12} - 1$$

before taking the log. Using the log of the cash rate means that simulated cash rates can never be negative.

Similarly, the bond yield converted from annual yield to effective monthly yield using the formula

$${( 1 + \frac{i}{100} )}^{1 / 12} - 1$$

Using the log of the bond yield minus the log of the cash rate is intended to reflect the yield curve.

Regarding the fitted parameters Property (direct) asset, they were μ=0.001, σ=0.008 to produce a return-variance for property that was in line with the other asset classes. In one embodiment, it is assumed that the true variance in property prices is higher than indicated by historic Index data because:
individual properties are likely to experience more price variability than the index, and investors are not able to easily diversify in the residential property market
some of the variability is masked by low auction clearance rates i.e. people don't sell if prices are too low, but if they had to sell then they would have to accept a lower price than indicated by those properties that are sold at auction and which prices are included in the index.

Following is the correlation matrix.

In one embodiment, the simulated annual returns were based on the above functions, parameters and correlation matrix. Monthly returns are capped at the historical maximum for each asset class, but no limit is applied on the downside.

In another embodiment, for the fixed interest, the monthly return was calculated as the change in a value of a 5-year bond over the month based on simulated yield at the start of the month and simulated yield at the end of the month. A coupon of 5% was assumed and the bond value at the end of the month is calculated based on 59 months to maturity (as one month has elapsed). This is intended to represent marking to market of a notional 5-year bond based no prevailing yields.

In yet another embodiment, for the property, the net rental income of 3.5% p.a. was added to the change in the price index to produce a total return.

In another embodiment, for equities a dividend yield of 4% p.a. is assumed for Australian equities and 2.75% p.a. for International Equities (DJIA).

The chart below shows an example of the geometric mean and standard deviation of 2000 simulations of annual returns over 75 years for each of the asset classes, in order from lowest to highest, Cash, Fixed Interest, Property (adjusted), Australian equities and International equities (DJIA). The x-axis shows total gross returns i.e. including coupons, net rental income, dividends and capital gains.

In one embodiment, the investment tax is further taken into consideration. Investment tax is calculated directly from simulated returns and allowing for interest, coupons, net rental income, dividends, capital gains and imputation credits. The following table shows how these are taxed.

| Asset Class | Taxable Income | Taxable Capital Gains |
|---|---|---|
| Cash | Total return taxed | None |
| Fixed | 5% p.a. coupon taxed | 50% of (total return less |
| Interest | | 5% p.a. coupon) |
| Property | 3.5% net rental income taxed | 50% of (total return less |
| (direct) | | 3.5% p.a. net rental |
| | | income) |
| Australian | 4% p.a. dividend plus franking | 50% of (total return less |
| equities | credit taxed, tax reduced by | 4% p.a. dividend) |
| | franking credit. Dividends | |
| | assumed to be 75% franked. | |
| International | 2.75% dividend taxed | 50% of (total return less |
| equities | | 2.75% p.a. dividend |

The tax rate for super is 15% before retirement (after preservation age) and 0% thereafter (assumes allocated pension). Non-super investment income is taxed at marginal rate after allowing for salary/wages.

Based on the above assumption, the calculator 10 has defined the following variables.
t=projection year (t=0 is current position)
Income=Current salaries & wages (i.e. taxable non-investment income)
Age(t)=Age at time t
RetAge=Retirement age for client (input)
TargetSFAge=Target shortfall age for clients i.e. age at which retirement funds are exhausted (input)
TargetLegacy=Legacy at target shortfall age (Input)
PresAge=Preservation age for client (based on client year of birth)
FullAccessAge=Age at which people have full access to their superannuation assets (input)
MinPension(x)=Legislated minimum pension (% super assets) to be withdrawn from super at age x (input)
MinPensionAmt(t)=Minimum pension ($) to be withdrawn from super by client in year t (calculated)
AgePensionAge=Age pension age for client (based on client year of birth)
AgePension=Current age pension (input)
DeemThresh=Threshold for deemed earning rates (input)
DeemRate(1)=Deemed earning rate on assets up to DeemThresh, for age pension income and assets test (input)
DeemRate(2)=Deemed earning rate on assets above DeemThresh, for age pension income and assets test (input)
WorkBonus=reduction in assessable income if working after age pension age (input)
IncThresh=Income threshold for age pension income test (input)
IncReduction=Rate of reduction in age pension for income earned above IncThresh (input)
AssThreshMin=Minimum assets for age pension assets test (depends on single/couple, own home/rent)
AssThreshMax=Maximum assets for age pension assets test (depends on single/couple, own home/rent)
AssReduction=Rate of reduction in age pension for assets above AssThreshMin (input)
DeemInc(t)=Deemed Income in year t for age pension income test (calculated)
DeemAss(t)=Deemed assets in current dollars at start of projection year t, for purposes of age pension calculation (calculated)
TotalInc(t)=Total income for in year t for age pension income test (calculated)
IncTestPension(t)=Age pension based on income test in year t (calculated)
AssTestPension(t)=Age pension based on assets test in year t (calculated)
AgePensionAmt(t)=Age pension ($) payable to client in year t (calculated)
FrankProp=Franked proportion dividends (input)
CorpTax=Corporate tax rate (input)
Thresh(1)=0 (input)
Thresh(2)=First marginal threshold for personal tax (input)
Thresh(3)=Second marginal threshold for personal tax (input)
Thresh(4)=Third marginal threshold for personal tax (input)
Thresh(5)=Fourth marginal threshold for personal tax (input)
Thresh(6)=Fifth marginal threshold for personal tax (input)
TRate(1)=0 (input)
TRate(2)=First marginal rate for personal tax (input)
TRate(3)=Second marginal rate for personal tax (input)
TRate(4)=Third marginal rate for personal tax (input)
TRate(5)=Fourth marginal rate for personal tax (input)
Medicare=Medicare levy (input)
CG(t)=Capital gain in year t (calculated)
DivInc(t)=Dividend income in year t (calculated)
FC(t)=Franking credits in year t (calculated)
TaxInvInc(t)=Taxable Investment Income in year t (calculated)
invTax(t)=Tax on Investment Income in year t (calculated)
OthTax(t)=Tax rate on non-super investment earnings in year t (calculated)
HomeAss(t)=Value of own home at time t (except for t=0, calculated)
OthAss (t)=Other Assets (Non-Super Assets) at time t (except for t=0, calculated)
SupAss(t)=Super Assets at time t (except for t=0, calculated)
Liab(t)=short-term borrowings and clearing account ((except for t=0, calculated)
HomeLiab(t)=Mortgage on own home (except for t=0, calculated)
OthLiab(t)=Liabilities secured against investments outside of super and own home (except for t=0, calculated)
SupLiab(t)=Liabilities inside super at time t—SMSFs may borrow to invest—(except for t=0, calculated)
OthEQ=Allocation of other assets to Australian equities (input)
OthOE=Allocation of other assets to Overseas equities (input)
OthPR=Allocation of other Assets to property (input)
RetEQ(t)=Return on Australian equities in year t (simulated)
RetOE(t)=Return on Overseas equities in year t (simulated)
RetPR(t)=Return on property in year t (simulated)
EQDiv=Australian equities dividend yield (input)
OEDiv=Overseas equities dividend yield (input)
PRDiv=Property rental yield (input)
SupRet(t)=Weighted average net return on super assets in year t (simulated)
OthRet(t)=Weighted average gross return on other assets in year t (simulated)
LiabRet(t)=Interest rate on debt secured against investment in year t (simulated)
AWE(t)=Index of AWE at time t relative to time t=0 (simulated)
CPI(t)=Index of AWE at time t relative to time t=0 (simulated)
SupCFIn(t)=Cash flows (net contributions) into super assets in year t (input)
OthCFIn(t)=Cash flows (other savings) into non-super assets in year t (input)
CFOut(t)=Cash flows out (drawdowns from assets), other than retirement income (input)
CFOutAndP(t)=Cash flows out (drawdowns from assets) including retirement income (input)
ShortfallPreRetAge=number of years for which client would be short of funds prior to retirement (calculated)
ShortfallAge=Age at which client has exhausted all assets available to fund their retirement income (calculated)
ShortfallAssets=Amount of assets at ShortFallAge—should be negative (calculated)
ShortfallAssetsRetAge=Amount of assets at RetAge (calculated)

Referring to FIG. 3, the personal financial data received from the client input step 33, and the data generated from simulation data step 34 are piped through to a step 36 to set up current assets and future cash flows.

At the same time, the electronic calculator 30 of a preferred embodiment of the present invention synchronously carry out the generation of all asset allocation step 35 which determinates of all possible asset allocations.

The output data from the process 36 is put together with the data generated from the process 35 in the joining process 37, and then pipe through to the selection of first asset allocation process 38.

In the selection of first asset allocation step 38, the electronic calculator 30 of a preferred embodiment of the present invention selects one of the many assets arbitrarily. In another preferred embodiment, the electronic calculation randomly selects the first asset. In yet another embodiment, the user may select the priority of the first asset.

After an asset is selected, the electronic calculator 30 of an embodiment of the present invention proceed the step 39 of calculation of simulated investment return by projection year for the selected asset allocation.

In the process 39, the electronic calculator 10 of a preferred embodiment may carry out the calculation internally. In another embodiment, the electronic calculator 30 sends a request or invokes application program interface (API) to the backend system to retrieve the results. The backend system may carry out the calculations internally or forward the request to a network of servers on the Internet to carry out the calculations.

When the electronic calculator 30 has the results for step 39 of the simulated future investment returns for current asset allocation, the electronic 30 then set up variables for that asset simulation. The electronic calculation has a variable “Simulation” to keep track on the number of simulation carried out. Initially for the first simulation, the “Simulation” variable is assigned to 0 as set out in step 40.

Following the step 40, the electronic calculator 10 proceed to step 41 to set up the “Projection Year” variable and set it to 0 and increment the “Simulation” variable by 1. Following step 41 is step 42 where the “Projection Year” variable is increment by 1.

Then the electronic calculator 30 proceeds to step 43 where the electronic calculator 30 calculates the minimum drawdown, age pension and the tax in a year. In this step the electronic calculator 30 will calculate the tax on non-super investment income, the tax payable on gross income; the minimum allocated pension drawdown; and age pension amount.

In step 43, the electronic calculator 30 derives the tax on non-super investment income with the following algorithm:

```
CG(t) = OthAss(t − 1)
              × (QthEQ × (EQRet(t) − EQDiv) + OthOE × (OERet(t) − OEDiv) + OthPR
              × (PRRet(t) − PRDiv))
DivInc(t) = OthAss(t − 1) × OthEQ × EQDiv
$FC ( t ) = DivInc ( t ) \times FrankProp \times \frac{CorpTax}{( 1 - CorpTax )}$
$TaxInvInc ( t ) = OthAss ( t - 1 ) \times OthRet ( t ) + FC ( t ) - \frac{CG ( t )}{2} - OthLiab ( t - 1 ) \times LiabRet ( t )$
If Age(t) < RetAge then
  $InvTax ( t ) = ( Tax ( \frac{TaxInvInc ( t )}{AWEInd ( t )} + Income ) - Tax ( Income ) ) \times AWEInd ( t )$
Else
  $InvTax ( t ) = Tax ( \frac{TaxInvInc ( t )}{AWEInd ( t )} ) \times AWEInd ( t )$
End if
If OthAss(t − 1) × OthRet(t) <> 0 then
  $InvTax ( t ) = Tax ( \frac{TaxInvInc ( t )}{AWEInd ( t )} ) \times AWEInd ( t )$
  $OthTax ( t ) = \frac{tnvTax ( t ) - FC ( t )}{OthAss ( t - 1 ) \times OthRet ( t )}$
Else
  OthTax(t) = 0
Endif
```

In step 43, the electronic calculator 10 derives the tax payable on Gross Income (GrossInc) as per above calculation of Tax on Non-Super Investment Income with the following algorithm:

Tax = 0
For i = 1 To 5

Tax = Tax

+ Max(Min(GrossInc − Thresh(i), Thresh(i + 1) − Thresh(i))
× TRate(i), 0)

Next i
Tax = Tax + Medicare × GrossInc

In step 43, the electronic calculator 10 derives the Minimum Allocated Pension Drawdown with the following algorithm:

If Age(t) > RetAge And Age(t) > PresAge Then

MinPensionAmt(t) = SupAss(t − 1) × MinPension(Age(t))

Else

MinPensionAmt(t) = 0

Endif

In step 43, the electronic calculator 30 derives the Age Pension Amount with the following algorithm:

```
$DeemAss ( t ) = \frac{SupAss ( t - 1 ) + OthAss ( t - 1 ) - Liab ( t - 1 )}{CPIInd ( t - 1 )}$
If Age(t) < AgePensionAge Then
  AgePensionAmt(t) = 0
ElseIf (Age(t) < RetAgeAndIncome > IncThreshx26 + WorkBonus)or(DeemAss(t)
            > AssThreshMax) Then
  AgePensionAmt(t) = 0
Else
  DeemInc(t) = DeemAss(t)xDeemRate(1)
            + Max(DeemAss − DeemThresh, 0)x(DeemRate(2) − DeemRate(1))
  $TotalInc ( t ) = \frac{DeemInc ( t ) + Max ( Income - WorkBonus , 0 )}{26}$
  IncTestPension(t) = (TotalInc(t) − IncThresh) × IncReduction
  AssTestPension(t) = (DeemAss(t) − AssThreshMin) × AssReduction
  AgePensionAmt(t)
            = CPIInd(t − 1)
            × Max ((AgePension − Max(IncTestPension(t) , AssTestPension(t), 0)), 0)
            × 26
Endif
```

After the electronic calculator 10 computed the minimum drawdown, age pension and the tax in year, the electronic calculator proceed to step 44 to calculate assets and liabilities at end of each projection year.

In step 44, the electronic calculator derives the assets and liabilities at end of each projection year with the following formulae.

```
Liab(t) = Liab(t − 1) × (1 + LiabRet(t)) + OthLiab(t − 1) × LiabRet(t)
              + (CFOutAndP(t) − MinPensionAmt(t) − AgePensionAmt(t) − OthCFIn(t))
              + (1 + LiabRet(t))^{0.5}
SupLiab(t) = SupLiab(t − 1)
OthLiab(t) = OthLiab(t − 1)
HomeLiab(t) = HomeLiab(t − 1)
OthAss(t) = OthAss(t − 1) × (1 + OthRet(t) × (1 − OthTax(t)))
SupAss(i, j) = SupAss(t) × (1 + SupRet(t))
              + (SupCFIn(t) − MinPensionAmt(t)) × (1 + SupRet(t))^{0.5} − SupLiab(t − 1)
              × LiabRet(t) × (1 − SupInvTax)
HomeAss(t) = HomeAss(0) × AWEInd(t)
If Age(t) ≥ RetAge Then
  Liab(t) = Liab(t) + HomeLiab(t)
  HomeLiab(t) = 0
  SupAss(t) = SupAss(t) − SupLiab(t)
  SupLiab(t) = 0
EndIf
If OthAss(t) < OthLiab(t)Then
  Liab(t) = Liab(t) + (OthLiab(t) − OthAss(t))
  OthAss(t) = 0
  OthLiab(t) = 0
ElseIf OthAss(t) < Liab(t) Then
  Liab(t) = Liab(t) − OthAss(t)
  OthAss(t) = 0
Else
  OthAss(t) = OthAss(t) − Liab(t)
  Liab(t) = 0
EndIf
If (Age(t) < PresAge or (Age(t) ≥ PresAge and
      Age(t) < RetAge and Age(t) < FullAccessAge)) and Age(t) < TargetSFAge Then
If HomeAss(t) < Liab(t) Then
    ShortfallPreRet = ShortfallPreRet + 1
EndIf
Else
If SupAss(t) < Liab(t) Then
    Liab(t) = Liab(t) − SupAss(t)
    SupAss(t) = 0
Else
  SupAss(t) = SupAss(t) − Liab(t)
  Liab(t) = 0
EndIf
EndIf
TotAss(t) = OthAss(t) − OthLiab(t) + SupAss(t) − SupLiab(t) + HomeAss(t) − HomeLiab(t)
              − Liab(t)
$If \frac{TotAss ( t )}{CPIInd ( t )} > TargetLegacy Then$
      ShortfallAge = Age(t)
      ShortfallAssets = TotAss(t)/CPIInd(t)
EndIf
$If Age ( t ) = RetAge Then ShortfallAssetsRetAge = \frac{TotAss ( t )}{CPIInd ( t )}$
$If Age ( t ) = TargetSFAge Then ShortfallAssetsTargetSFAge = \frac{TotAss ( t )}{CPIInd ( t )}$
```

At the end of step 44, the electronic calculation of a preferred embodiment of the present invention may preferably obtain the amount of asset and liability. The results preferably then pipe through to step 45 to check whether the net assets is smaller than the legacy and the age is greater than the target age. In the event that it is negative, the electronic calculator may loop back to step 42 to calculate the minimum drawdown, age pension, tax, asset and liability for another year, In the event that the answer is positive, the electronic calculator may proceed to perform step 46 and onwards again.

In step 46, the electronic calculator 10 may determine whether it has reached the last simulation. In the event that it has not, it will loop back to perform step 41 and onwards again. In the event that it has reached the last simulation, it will proceed to carry out step 47.

In step 47, the electronic calculator may sort the simulations retirement income and determine risk penalties, and then store the result in a persistent memory unit or volatile memory unit.

After the results data is stored in the memory, the electronic calculator 30 proceed to step 48 to check whether the last asset allocation is carried out as shown in step 48. In the event that it has not, the electronic calculator 30 will loop back to step 39 and proceeds onwards from there. In the event that all the asset allocation is completed, the electronic calculator will proceed to step 49 for selected risk percentile sort asset allocation based on retirement income.

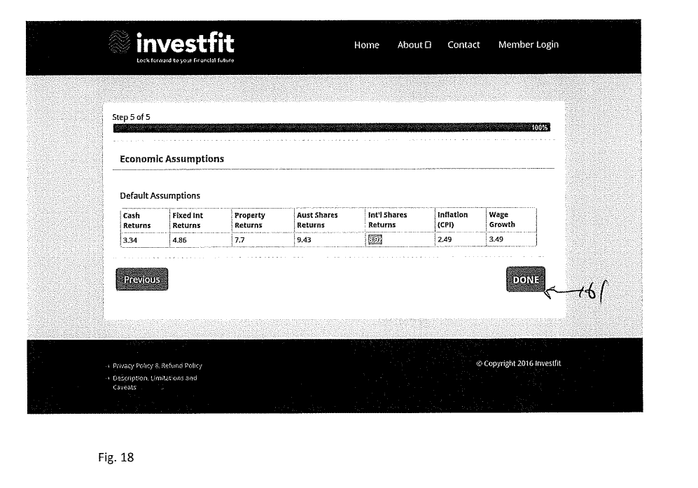

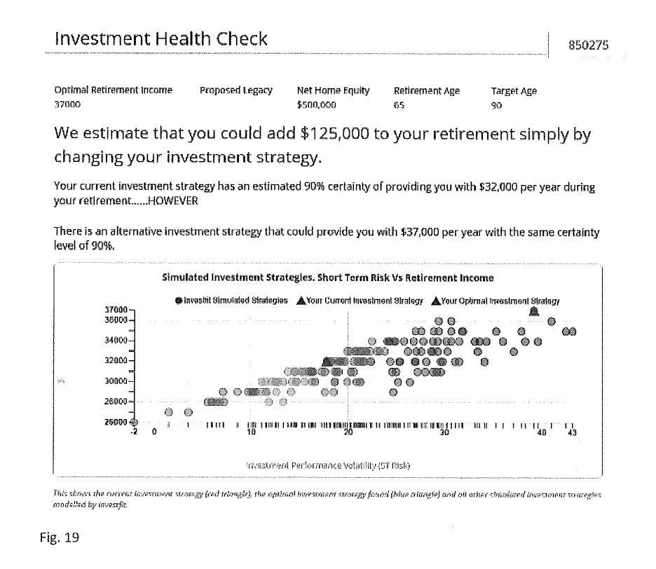

Then the electronic calculator 30 proceed to step 50 to select the optimal asset allocation and calculate key outputs and generate the outputs in step 51 as shown in FIGS. 18 and 19.

The after the output and presenting the report on the display of the electronic calculator 30, it further carries out s number of tests.

In the first test, the electronic calculator 30 does changing the current portfolio to the optimised portfolio improve the user's retirement income by more than 5%. If it does, then they will receive a statement suggesting they should speak with the financial adviser to find out what their optimal portfolio is. If not the preferred system runs the second test.

In the second test, the user's retirement income higher than the ASFA recommended minimum threshold needed for a comfortable retirement. If not, the electronic calculator 30 or backend system will issue a statement to the user referring the case to an adviser to find out how to improve their retirement income and meet the ASFA recommended minimum. This is strategic advice as opposed to investment advice. If they do meet the ASFA minimum then the program runs the third test:

In the third test, the user receives a statement alerting them that they could add a dollar amount to their retirement income by saving a certain dollar amount of their weekly earnings. And if they wanted to know more about this then they should send in their contact details.

There may be also a fourth test for retired users alerting them that they may be able to leave a legacy for beneficiaries if they spend less in their retirement, and to send in their contact details if they wanted to find out how to do this.

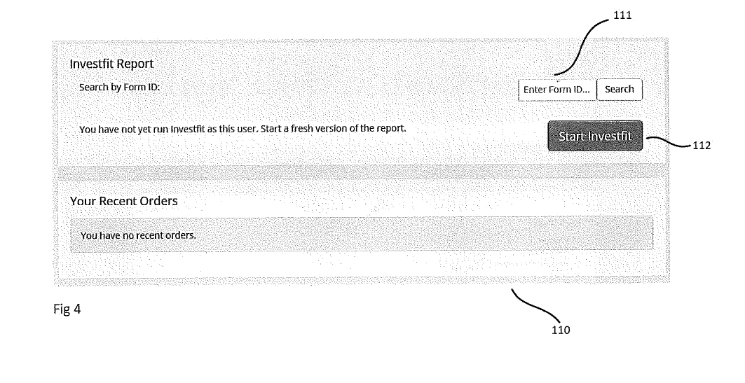

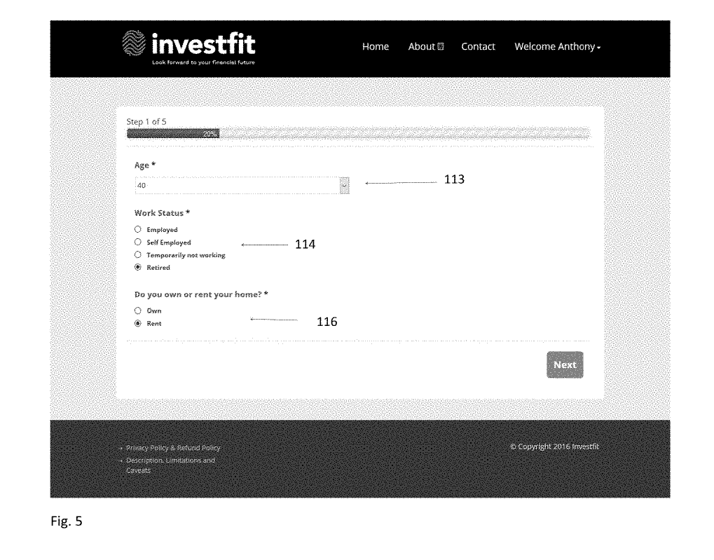

Referring to FIG. 4, there is provided an interface 110 for a user to start generating a report. The user may enter a form ID of a previous report in the textbox 111 to retrieve a previous report. Alternatively, a user may click on a start button 112 to start a new report. When the user clicks on the start button 112, the system will take the user to FIG. 5.

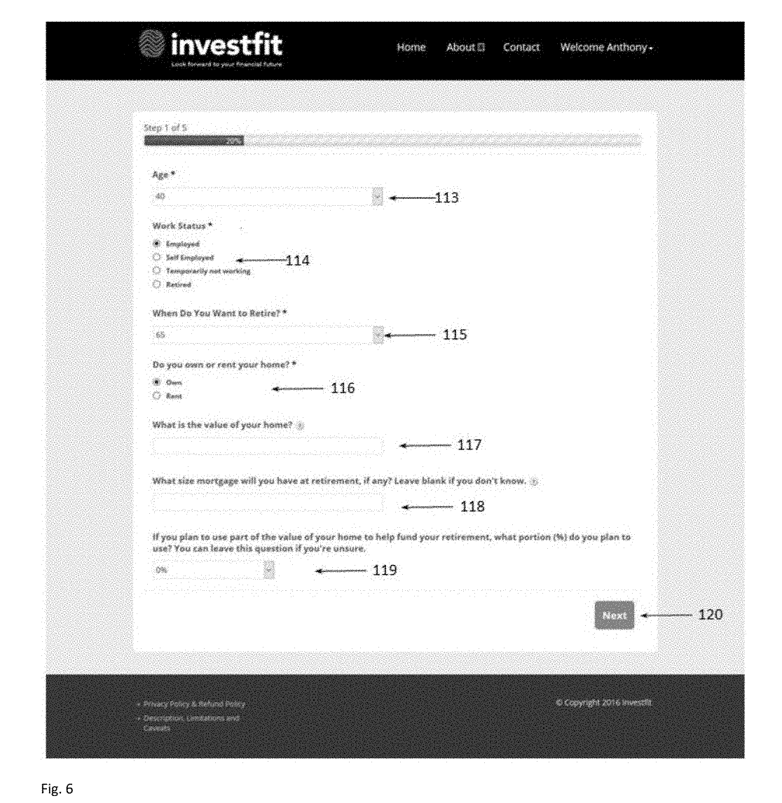

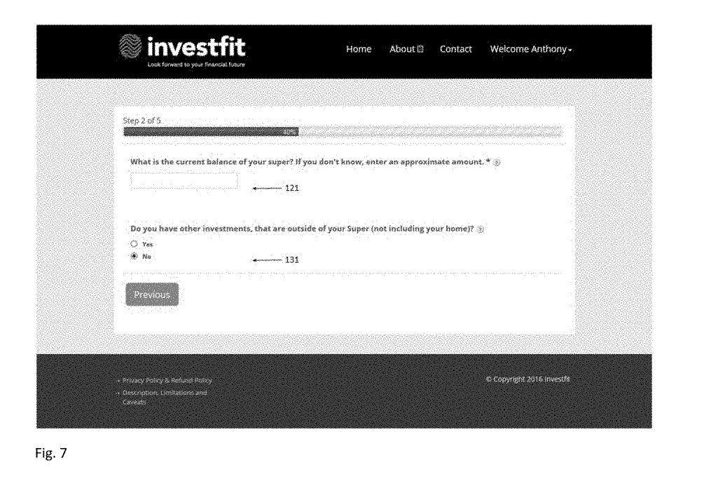

In FIG. 5, the user has to select his or her age in the selection box 113. Then the user may choose his or her work status from the radio options button 114. If a user chooses the options “Employed”, “Self Employed” or “Temporarily not working”, the user has to further specified the retirement age in a retirement age selection box 115 as shown in FIG. 6 Then the user has to select whether he or she owns a home from the radio option button 116. Should the “Own” option is selected, the user has to response a few more question regarding to his or her home as shown in FIG. 6. Referring to FIG. 6, the user need to further: (i) input the value of his or home the text box 117, (ii) input the expect size of the mortgage at the retirement age specified in 115 in the text box 118; and (iii) select the percentage the value of the home expected to fund the retirement in selection box 119. The percentage options available to be selected in the selection box 119 is in the multiple of 10. However, in another embodiment, a user may input the exact percentage in a text box provided by the system. After the user provided all the above data to the system 10, the use click the “Next” button 120 to proceed to the next interface FIG. 7.

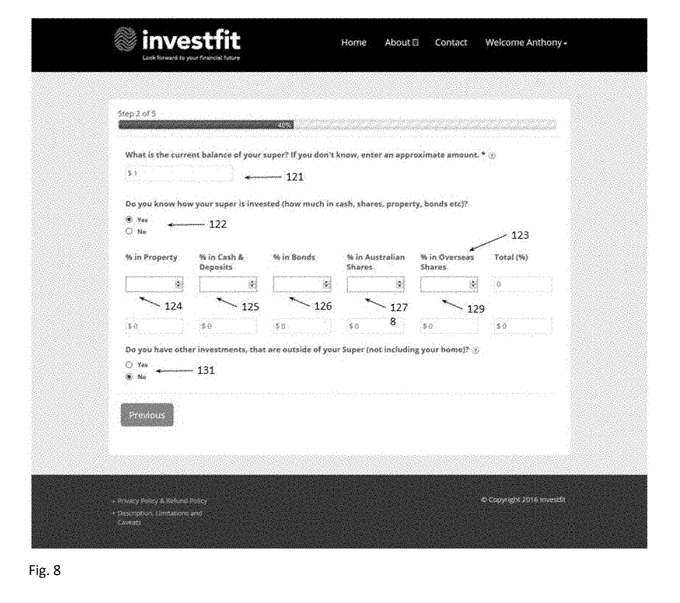

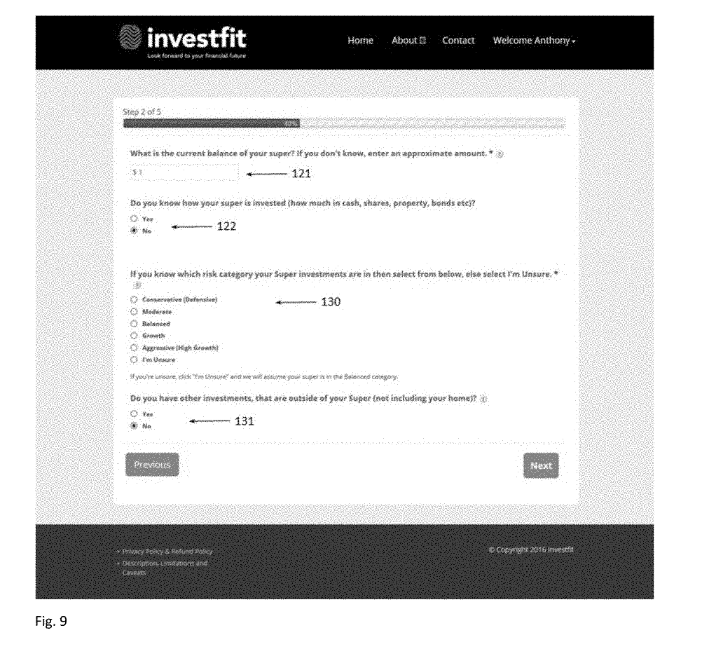

Referring the FIG. 7, the user has to input the current balance of the super annulation screen in the textbox 121. If the current balance is greater than 0, the system will ask the user to select whether he or she knows how the super annulation fund was invested in the radio options button 122. When the user chooses “Yes” in the radio options button in 122, the system will display a first extra option 123 for the user to input the distribution of the superannuation invention as shown in FIG. 8. The first extra option 123 allows the user to input the percentage of the superannuation invested in: (i) property 124; (ii) cash and deposit 125; (iii) bonds 126; (iv) Australian Shares 128; and (v) Overseas Shares 129. When the user chooses “No” in the radio options button in 122, the system will display a Second extra option 130 for the user to select the risk category of the superannuation invention from the radio options buttons as shown in FIG. 9.

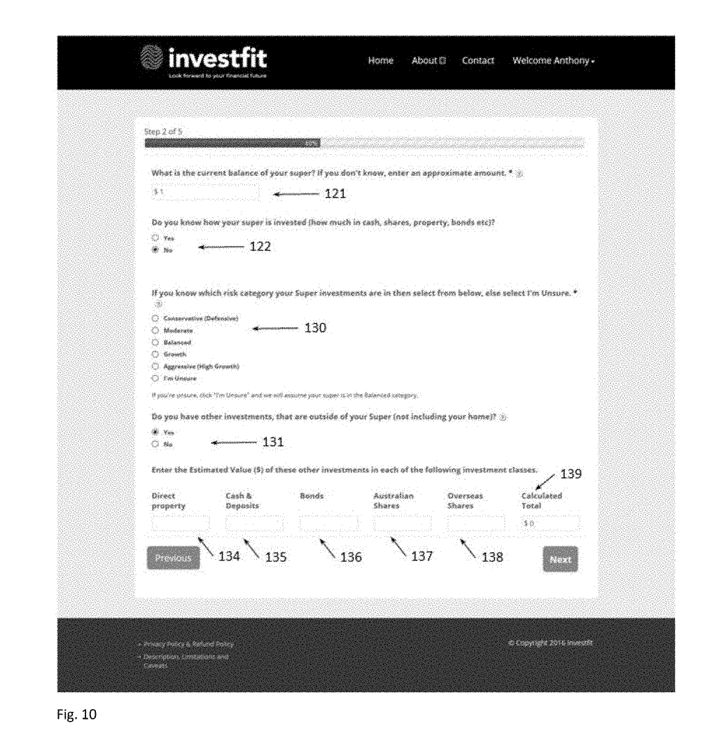

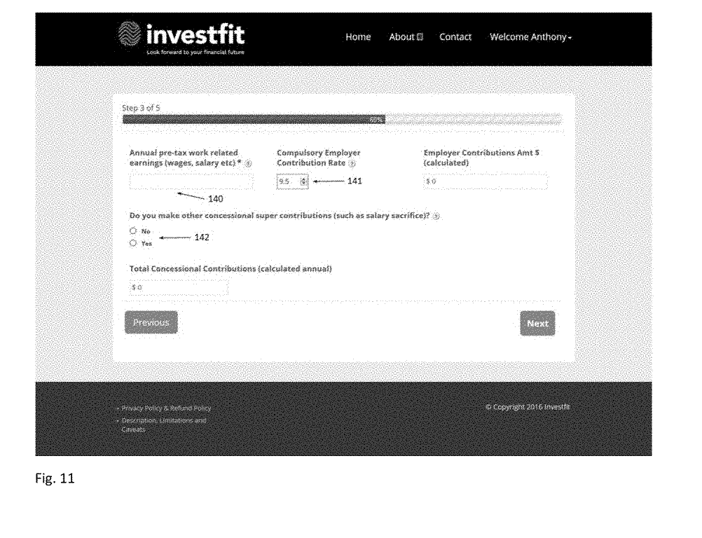

Then the user may answer the question of whether he or she has additional investment other than superannuation and his or her home by selecting “Yes” or “No” from the radio options button 131. When the user chooses “Yes” in the radio options button in 131, the system will display a third extra option 132 for the user to input the distribution of the superannuation invention as shown in FIG. 10. The third extra option 133 allows the user to input the percentage of the superannuation invested in: (i) property 134; (ii) cash and deposit 135; (iii) bonds 136; (iv) Australian Shares 138; and (v) Overseas Shares 139. After the user inputs all the information, he or she may click the next button and the system will proceed to display the next interface FIG. 11. If the user prefers to review previous input data, he or she can click the “Previous” button to go back to the previous interface.

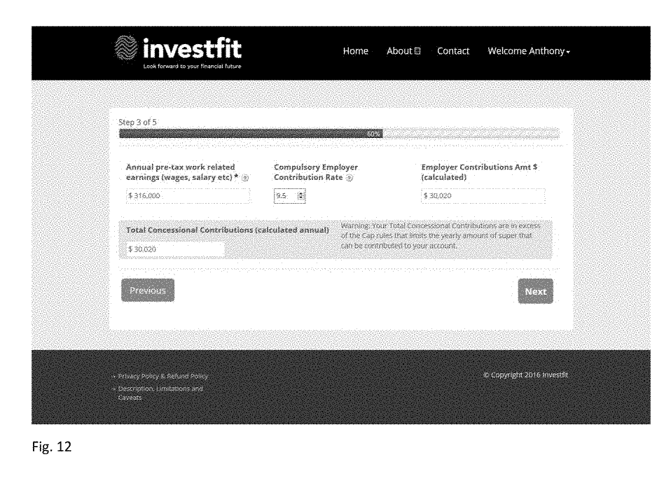

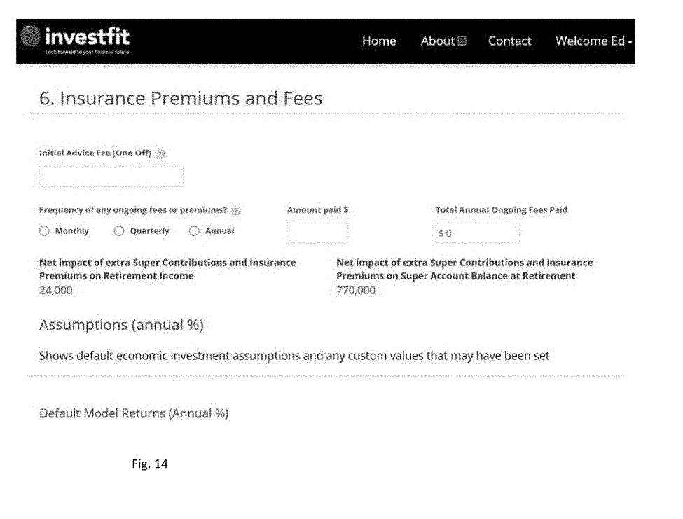

Referring to FIG. 11, the user may enter the annual pre-tax salary to the electronic calculator 10 in the textbox 140. According to the adjustable contribution rate in the input box 141, the electronic calculator 10 can immediate calculate the total annual contribution of the superannuation. Typically there is a limit on the contribution known as the cap value. If the calculated contribution exceeds the cap value, an extra levy will be incurred. If the calculated contribution exceeds the cap value, the electronic calculator 10 will display a warning sign to alert the user as shown in FIG. 12. Otherwise, the electronic calculator 10 will display a radio options button 142 inquiring whether the user will make an extra contribution to the superannuation. If the user chooses “Yes”, the electronic calculator 10 will display extra options asking the interval of the contribution in the radio options button 143 and the amount of extra contribution in text box 144. With the above information, the electronic calculator 10 can derive the annual contribution to the superannuation and display a textbox on the interface. After the user input all the data, he or she may click on the next button 145 to proceed to the next interface Screen FIG. 14. If the user prefers to review previous input data, he or she can click the “Previous” button to go back to the previous interface.

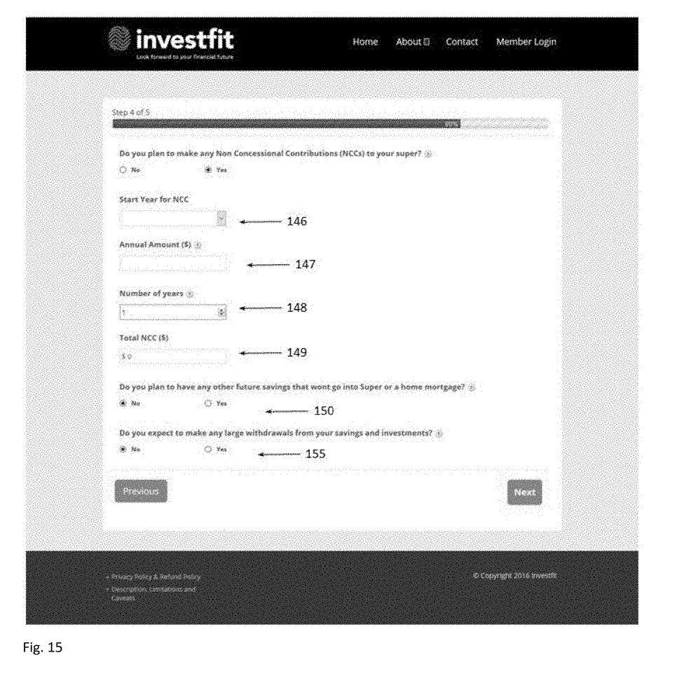

Referring to FIG. 15, the user may answer the electronic calculator 10 whether he or she makes any non-concessional contribution (NCC) to the superannuation fund by choosing “Yes” or “No” from the selection options button. When the user choose “Yes”, the electronic calculator 10 will provides NCC extra options for the user to specify the amount of the NCC as shown in FIG. 15 including: (i) that start year of NCC in the selection box 146, (ii) the annual amount of the NCC in the textbox 147; and (iii) the number of years of contribution in the selection box in 148. With this extra NCC information, the electronic calculator 10 will immediately calculate the total amount of NCC and display in the textbox 149.

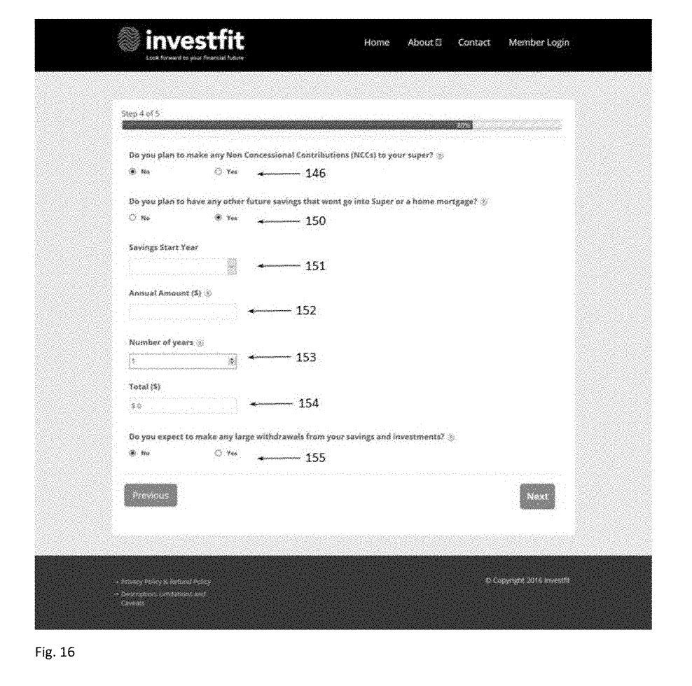

The user may then answer the system 10 whether he or she has a plan to have savings other than superannuation fund and home by choosing “Yes” or “No” from the selection options button 150. When the user chooses “Yes”, the electronic calculator 10 will provide extra saving options for the user to specify the amount of the saving as shown in FIG. 16 including: (i) that start year of savings in the selection box 151, (ii) the annual amount of the saving in the textbox 152; and (iii) the number of years of contribution in the selection box in 153. With these extra savings information, the electronic calculator 10 will immediately calculate the total amount of savings and display in the textbox 154.

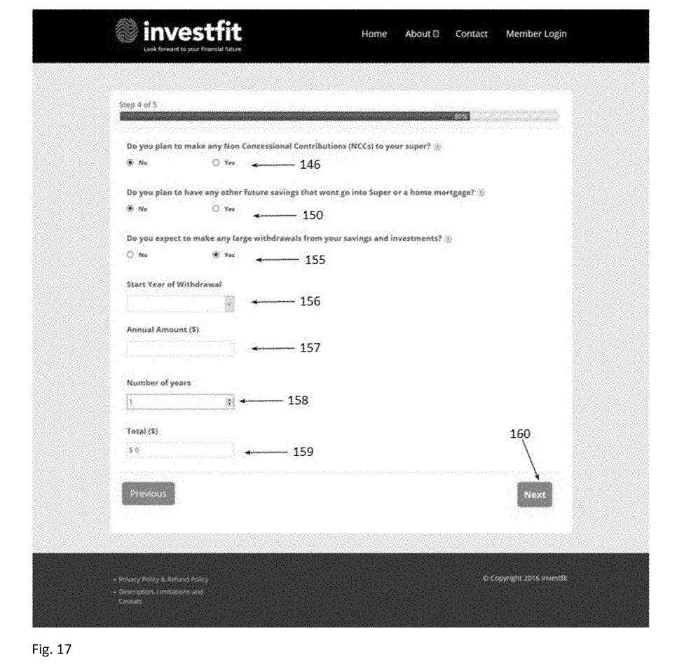

Further, the user may answer the electronic calculator 10 whether he or she has a plan to have large withdrawals from the savings and investments by choosing “Yes” or “No” from the selection options button 155. When the user chooses “Yes”, the electronic calculator 10 will provide the withdrawals options for the user to specify the amount of the withdrawals as shown in FIG. 17 including: (i) that start year of withdrawals in the selection box 156, (ii) the annual amount of the withdrawals in the textbox 157; and (iii) the number of years of withdrawals in the selection box in 158. With these extra information, the electronic calculator 10 will immediately calculate the total amount of savings and display in the textbox 159. After the user input all the data, he or she may click the next button 160 to proceed to the next interface FIG. 18. If the user prefers to review previous input data, he or she can click the “Previous” button to go back to the previous interface.

Referring the FIG. 18, the electronic calculator 10 listed a number of predetermined economic parameters used to generate the report. These economic parameters include: cash returns rate which is 3.34, fixed interest return rate which is 4.86, property returns rate which is 7.7, Australian shares returns rate which is 9.43, International share return rate which is 8.92, inflation rate (CPI) which is 2.49, and wage growth rate which is 3.49. These parameters are stored in the electronic calculator 10 and the user may view these assumptions but he or she cannot change them. In one embodiment, these parameters are download from a third party providers. After the user reviews all the economic parameters he or she may click the “Done” button 161 to proceed to the next interface FIG. 19. If the user prefers to review previous input data, he or she can click the “Previous” button to go back to the previous interface.

After the user clicks the “Done” button 161, the electronic calculator 10 will forward data to an array of processors to search the closest portfolio and use the input data to extrapolate future projection.

The electronic calculator 10 first calculates the financial portfolio with the current data given by the user.

The electronic calculator 10 then searches through millions of portfolios for similar input data, and create an interactive report.

In one embodiment, there are eight sections on an interactive report. An example of each section is shown in FIG. 19 to FIG. 27. In the first section, as shown in FIG. 19, the electronic calculator 10 lists a set of different possible portfolios on a simulated investment graph 162. The outcomes of the current investment strategy and the optimal invest strategy are highlighted for the convenience of the user to compare the difference.

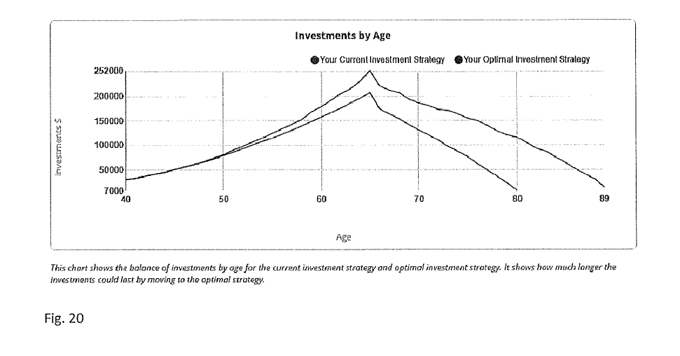

In the second section as shown in FIG. 20, the electronic calculator 10 then displays the investments by age graph 163 to show the user the amount of investment from now to post-retirement years. There are two lines: one represents the current investment strategy, and the other represents the optimal investment strategy.

In one embodiment, when a brief report is required, the electronic calculation 10 will only display the above two section. When a more comprehensive report is required, the calculator will display the following 6 sections.

Each of the following 6 sections provides a user interface for a user to adjust and alter the input parameter to simulate other investment scenario in real-time.

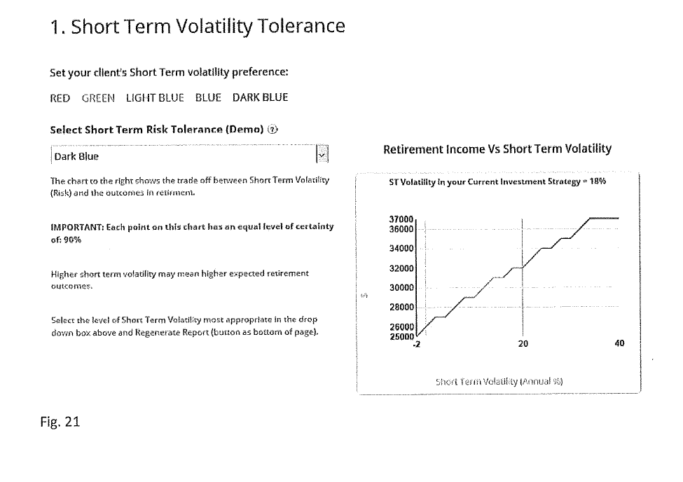

In the third section as shown in FIG. 21, the electronic calculator 10 displays a graph regarding the short-term volatility tolerance of the investment strategy. The user may simulate a different kind of short-term volatility to compare the investment outcome. In this section, the electronic calculator 10 provides a selection box 171 for a user to select different level of short term volatility to investigate the different outcome.

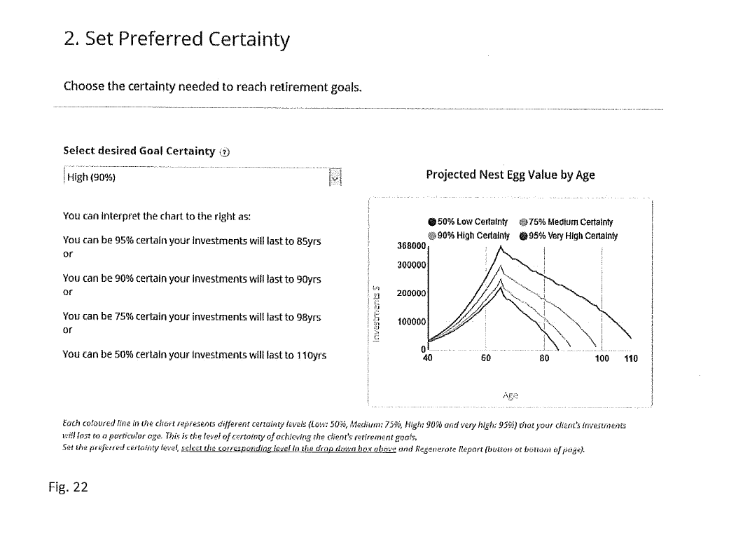

In the fourth section as shown in FIG. 22, the electronic calculator 10 displays a graph relates to the certainty needed to reach retirement goal. For example, the default certainty levels may be:
95% that the investment will last to 85 years old;
90% that the investment will last to 90 years old;
75% that the investment will last to 98 years old; or
50% that the investment will last to 110 years old.

In the graph, each of the lines on the chart may represent different certainty levels that the investments will last to a particular age. This is the level of certainty of achieving the user's retirement goal.

In this section, the electronic calculator 10 provides a selection box 173 for a user to select different certainty levels to compare the changes in the investment outcome.

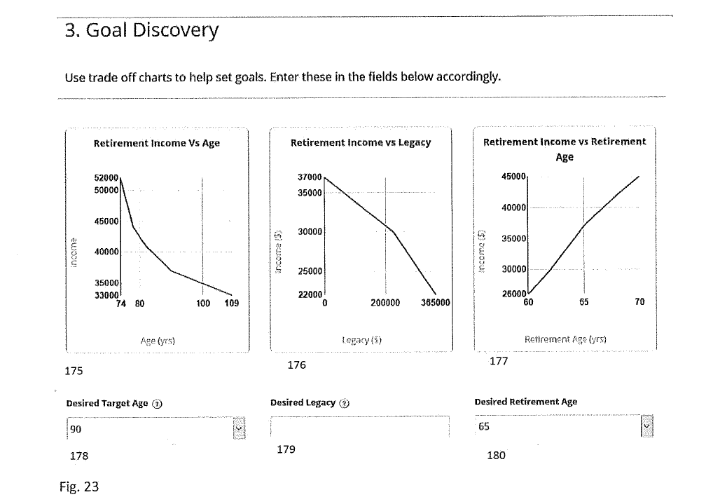

In the fifth section as shown in FIG. 23, the electronic calculator 10 displays three graphs: the retirement against the age graph 175, the retirement income against the legacy graph 176, and the retirement income against retirement age graph 177. These graphs present different trade-off situation a user can make to achieve a different outcome.

Under the retirement against the age graph 175, there is provided a selection box 178 for a user to adjust the desired target age for the retirement against the age graph 175. Under the retirement income against the legacy graph 176, there is provided a textbox 179 for a user to specify or change the amount of legacy left behind on the retirement income against the legacy graph. Under the retirement income against retirement age graph 177, there is provided a selection box 180 for a user to adjust the desired retirement age for the retirement income against retirement age graph.

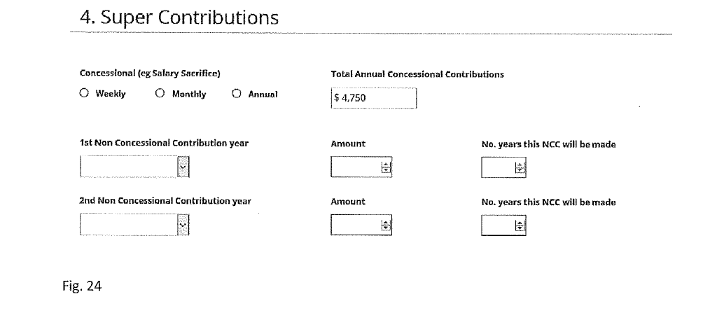

In the sixth section as shown in FIG. 24, the electronic calculator 10 displays a superannuation contribution form. In this form, the user may change the amount of the superannuation contribution.

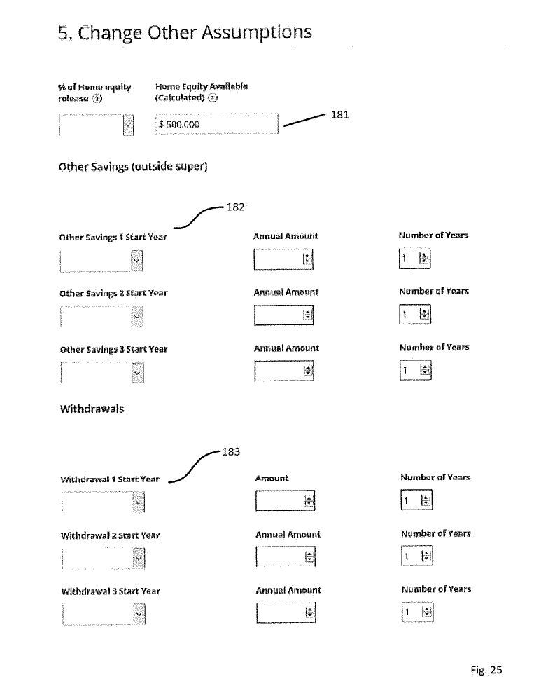

In the seventh section as shown in FIG. 25, the electronic calculator 10 displays a form allowing the user to change other assumptions including the home equity 181, other saving 182, and withdrawal 183.

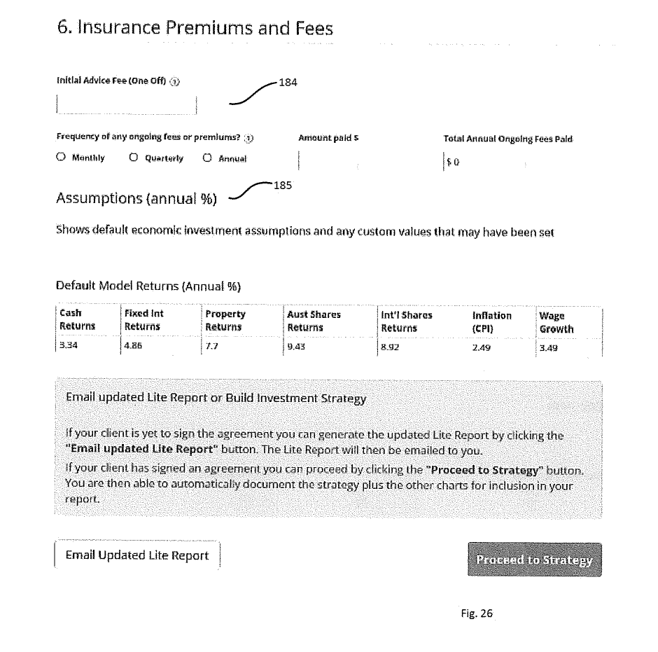

In the eighth section as shown in FIG. 26, the electronic calculator 10 displays a form 184 to take insurance premium and fee into consideration. Below the form 184, the assumptions on economic data 185 are displayed.

Further in this section, there is an email option button 186 for a user to obtain a report in email. When a user clicks on this button, the electronic calculator will email a report to the user in portable document format. On the opposite side of the mail option button 186, there is a “proceed to strategy” button 187. When the “proceed to strategy” button 187 is activated, the electronic calculator 10 will collect new data and generate a new report.

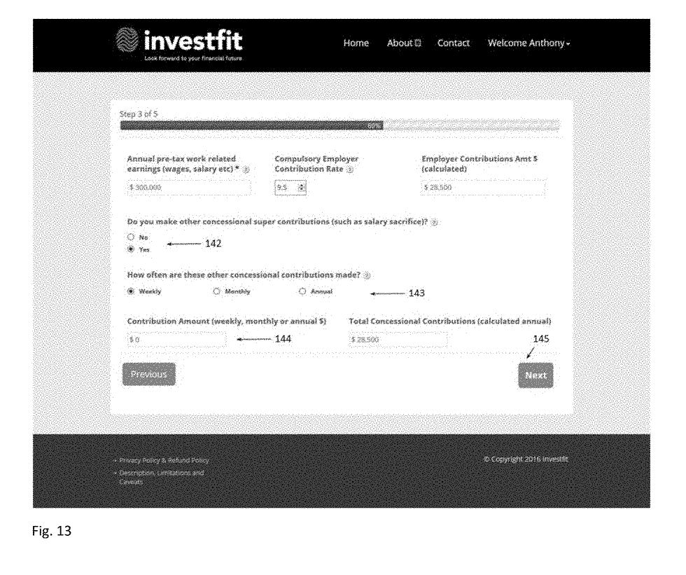

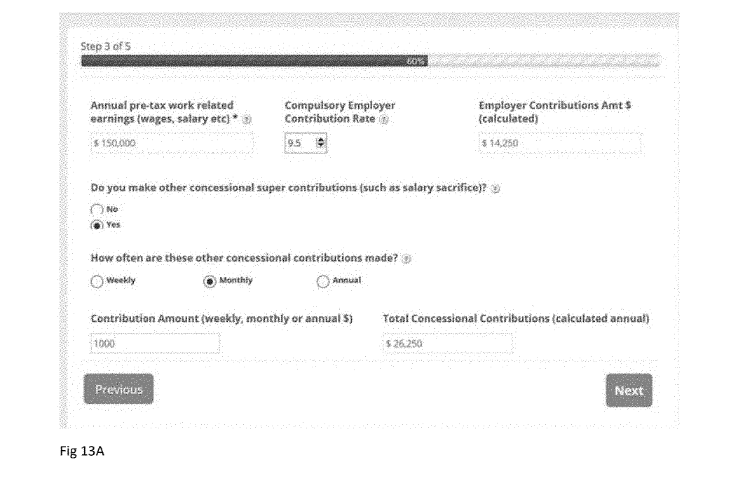

Additionally, if a user adds concessional contributions such as salary sacrifice contributions to the input screen shown in FIG. 13. Two additional fields may appear within the interactive report shown in FIG. 26. The first additional fields may read “net impact of extra super contributions and insurance premiums on retirement income” and the system calculates and displays the appropriate value. The second additional field may read “net impact of extra super contributions and insurance premiums on super account balance at retirement” and the system calculates and displays the appropriate value. The first and second additional fields described in this paragraph are not shown in FIG. 26, but an appropriately skilled person in the art would understand that these fields and displayed values may be added to the display shown in FIG. 26.

In an alternative embodiment of the present invention, there is provide an electronic system comprising a computing terminal acting as an electronic calculator 10. Typically, an electronic calculator 10 is a handheld device with its own input and output device integrated or embedded into the same handheld unit. Typically a computing terminal comprises a main body housing one or more central processing units, memory, I/O interface connecting to an external keyboard, point device and display unit. The main body also houses a network interface such as Ethernet network card, Wi-Fi network card or blue tooth network card.

In another embodiment of the present invention, the process of carrying out a function of the electronic calculator 10 is encoded on an electrical/electromagnetic/optical media as a software code, typically known as app or program. When the app or program is loaded to a computing device such as a generic computer or universal tuning machine, or a smart device (smart phone/tablet), the generic computer can carry out the process of the electronic calculator 10.

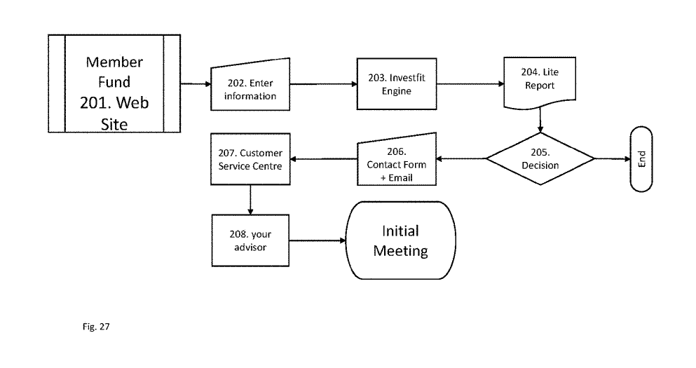

Referring to FIG. 27 shows a process of utilising the electronic calculator 10 of the present invention as a lead generation tool. In step 201, a user accesses the website through the electronic calculator 10. The user then enters information as shown in step 202. In step 203, the electronic calculator 10 carried out the process as described above in step 32 to step 50 as shown in FIG. 3.

After the electronic obtains the result, it displays an abridged version of the report as shown in step 204. The user may be satisfied with the abridged version of the report and decide to end the process.

In another event, the user can decide to fill in the contact form displayed on the electronic calculator 10 and send an email to the customer service centre as shown in step 206. In step 207, the customer service centre receives the email request from the customer, and selects an advisor that is suitable to the portfolio of the user as in step 208. The advisor will contact and follow up with the customer, and starts an initial meeting.

In one embodiment, the calculator 10 delivers an end to end modelling process including Customer Fact Find, optimal asset allocation to projections that to go into the service-oriented architecture (SoA) within one customer facing session. The risk profiling process is simple, objective and is an alternative to disengaging risk profile questionnaires.

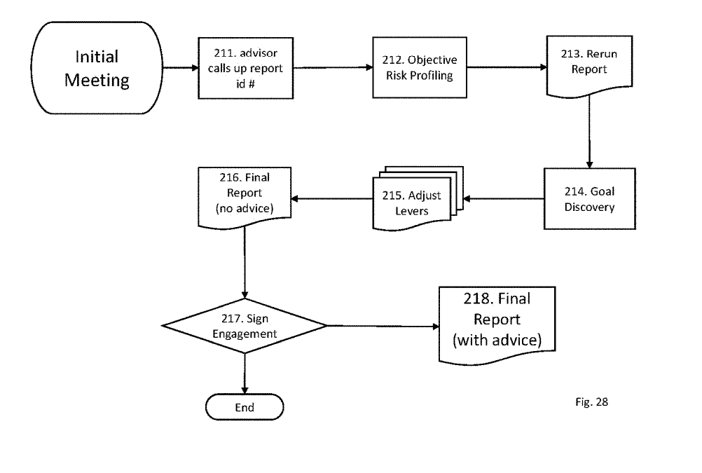

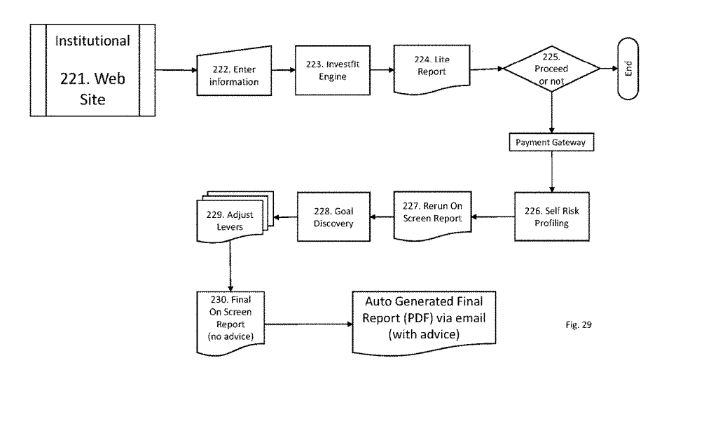

Referring to FIG. 28, the process initiates when an advisor initiates a meeting with a customer. In this scenario, the advisor is a user of the electronic calculator 10. In step 211, the advisor retrieves a report generated by the customer by inputting the report identification number to the electronic calculator 10 on the first interface design as shown in FIG. 4. The advisor conducts an objective risk profiling with the customer in step 212. In this step, the advisor and the customer engage in risk tolerance discussion based on the risk against outcomes trade-off chart as shown in FIG. 23. The advisor may adjust the risk tolerance values to demonstrate different goals.

Then the advisor re-runs the report as shown in step 213 with the new information. The advisor then walks through different goals with the customer in step 214, and adjusts different input parameters on display designs 23 to 26 as shown in step 215. The changes in these input parameters are required when a new goal is discovered and set. The changes include retention age, legacy, salary sacrifice etc.

The report can be re-run as many time until the customer is satisfied with the outcomes.

A final report then issued as shown in step 216. The customer may decide to sign an engagement agreement as in step 217 and engage the advisor for further advices on the final report.

In another embodiment, self-directed or lower net worth (C & D) customers or members can directly access the process themselves with the electronic calculator 10 and pay for it directly if they prefer.

In this embodiment, the customer is given the electronic calculator 10, in the form of a hardware device or remote access through a website in step 221. In this case, the customer is acting as a user of the electronic calculator 10. Referring to step 221, a user accesses the website through the electronic calculator 10. The user then enters information as shown in step 222. In step 223, the electronic calculator 10 carried out the process as described above in step 32 to step 50 as shown in FIG. 3. Then the electronic calculator 10 will provide an abridged version of the report to the user in step 224.

In step 225, the user may decide whether to proceed further or not. The electronic calculation will provide an electronic payment gateway to accept payment from a user in the event that the user decides to proceed.

The user than conducts a self-risk profiling in step 226 using the risk against goals trade off chart as shown in FIG. 23 to set preferred risk tolerance. In step 227, the electronic calculator 10 re-runs the process and present new report to the user. In step 228, the user may observe the goals and acceptability of these goals presented in the report on the electronic calculator 10.

The user may then adjust different input parameters on display designs 23 to 26 as shown in step 219. The changes in these input parameters are required when a new goal is discovered and set. The changes include retention age, legacy, salary sacrifice etc.

Once the user is satisfied with the financial outcomes, the user may proceed to finalise the report which can be automatically rendered as the portable document format and deliver to the use by email.

The present invention and the described preferred embodiments specifically include at least one feature that has industrial applicability.

What is claimed is:

1. An electronic calculator for carrying out a process of calculating an optimal cash flow for post-retirement stage, the process comprising the steps of:
receiving personal financial data from a user;
connecting to a database and retrieving simulation data; wherein the simulation data is integrated with the personal financial data to generate the current and future assets and cash flow data;
generating a set of assets for allocation;
connecting to a remote server, and forwarding at least part of current and future assets and cash flow data, simulation data, and the set of assets for allocations to carry out the steps of:
for each iteration of an asset in the set of assets for allocation, carry out the following simulations to generate a retirement income based on an associated risk percentile:
(i) calculate minimum drawdown, age pension and tax for each year;
(ii) calculating assets and liabilities at the end of a year, and
(iii) determine whether the net assets is less than legacy and age is greater than a target age
retrieving a selected risk percentile from the personal financial data;
sorting assets allocation based on the retirement income;
selecting optimal asset allocation; and
generating and displaying a report with the optimal asset allocation.

2. The electronic calculator of claim 1 wherein the tax for each year comprises any one or more of a tax on non-super investment income, and gross income tax.

3. The electronic calculator of claim 2 wherein the tax on non-super investment income is derived with the following algorithm:
```
CG(t) = OthAss(t − 1)
        × (QthEQ × (EQRet(t) − EQDiv) + OthOE × (OERet(t) − OEDiv)
        + OthPR × (PRRet(t) − PRDiv))
DivInc(t) = OthAss(t − 1) × OthEQ × EQDiv
$FC ( t ) = DivInc ( t ) \times FrankProp \times \frac{CorpTax}{( 1 - CorpTax )}$
$TaxInvInc ( t ) = OthAss ( t - 1 ) \times OthRet ( t ) + FC ( t ) - \frac{CG ( t )}{2} - OthLiab ( t - 1 ) \\ \times LiabRet ( t )$
If Age(t) < RetAge then
  $InvTax ( t ) = ( Tax ( \frac{TaxInvInc ( t )}{AWEInd ( t )} + Income ) - Tax ( Income ) ) \times AWEInd ( t )$
Else
  $InvTax ( t ) = Tax ( \frac{TaxInvInc ( t )}{AWEInd ( t )} ) \times AWEInd ( t )$
Endif
If OthAss(t − 1) × OthRet(t) <> 0 then
  $InvTax ( t ) = Tax ( \frac{TaxInvInc ( t )}{AWEInd ( t )} ) \times AWEInd ( t )$
  $OthTax ( t ) = \frac{tnvTax ( t ) - FC ( t )}{OthAss ( t - 1 ) \times OthRet ( t )}$
Else
  OthTax(t) = 0
Endif
```

4. The electronic calculator of claim 2 wherein the gross income tax as is derived with the following algorithm:
Tax = 0
For i = 1 To 5
Tax = Tax
+ Max(Min(GrossInc − Thresh(i), Thresh(i + 1) − Thresh(i))
× TRate(i), 0)
Next i
Tax = Tax + Medicare × GrossInc

5. The electronic calculator of claim 1 wherein the minimum drawdown is derived with the following algorithm:
If Age(t) > RetAge And Age(t) > PresAge Then
MinPensionAmt(t) = SupAss(t − 1) × MinPension(Age(t))
Else
MinPensionAmt(t) = 0
Endif

6. The electronic calculator of claim 1 wherein the age pension is derived with the following algorithm:
```
$DeemAss ( t ) = \frac{SupAss ( t - 1 ) + OthAss ( t - 1 ) - Liab ( t - 1 )}{CPIInd ( t - 1 )}$
If Age(t) < AgePensionAge Then
  AgePensionAmt(t) = 0
ElseIf (Age(t) < RetAgeAndIncome > IncThreshx26 + WorkBonus)or(DeemAss(t)
            > AssThreshMax) Then
    AgePensionAmt(t) = 0
Else
  DeemInc(t) =DeemAss(t)xDeemRate(1)
            + Max(DeemAss − DeemThresh, 0)x(DeemRate(2) − DeemRate(1))
  $TotalInc ( t ) = \frac{DeemInc ( t ) + Max ( Income - WorkBonus , 0 )}{26}$
  IncTestPension(t) = (TotalInc(t) − IncThresh) × IncReduction
  AssTestPension(t) = (DeemAss(t) − AssThreshMin) × AssReduction
  AgePensionAmt(t)
            = CPIInd(t − 1)
            × Max ((AgePension − Max(IncTestPension(t) , AssTestPension(t), 0)), 0)
            × 26
Endif
```

7. The electronic calculator of claim 1, wherein the assets and liabilities at the end of year is derived with the following algorithm:
```
Liab(t) = Liab(t − 1) × (1 + LiabRet(t)) + OthLiab(t − 1) × LiabRet(t)
            + (CFOutAndP(t) − MinPensionAmt(t) − AgePensionAmt(t) − OthCFIn(t))
            × (1 + LiabRet(t))^{0.5}
SupLiab(t) = SupLiab(t − 1)
OthLiab(t) = OthLiab(t − 1)
HomeLiab(t) = HomeLiab(t − 1)
OthAss(t) = OthAss(t − 1) × (1 + OthRet(t) × (1 − OthTax(t)))
SupAss(i, j) = SupAss(t) × (1 + SupRet(t))
            + (SupCFIn(t) − MinPensionAmt(t)) × (1+ SupRet(t))^{0.5} − SupLiab(t − 1)
            × LiabRet(t) × (1 − SupInvTax)
HomeAss(t) = HomeAss(0) × AWEInd(t)
If Age(t) ≥ RetAge Then
  Liab(t) = Liab(t) + HomeLiab(t)
  HomeLiab(t) = 0
  SupAss(t) = SupAss(t) − SupLiab(t)
  SupLiab(t) = 0
EndIf
If OthAss(t) < OthLiab(t)Then
    Liab(t) = Liab(t) + (OthLiab(t) − OthAss(t))
  OthAss(t) = 0
  OthLiab(t) = 0
ElseIf OthAss(t) < Liab(t) Then
  Liab(t) = Liab(t) − OthAss(t)
  OthAss(t) = 0
Else
  OthAss(t) = OthAss(t) − Liab(t)
  Liab(t) = 0
EndIf
If (Age(t) < PresAge or (Age(t) ≥ PresAge and
      Age(t) < RetAge and Age(t) < FullAccessAge)) and Age(t) < TargetSFAge Then
If HomeAss(t) < Liab(t) Then
    ShortfallPreRet = ShortfallPreRet + 1
EndIf
Else
If SupAss(t) < Liab(t) Then
    Liab(t) = Liab(t) − SupAss(t)
    SupAss(t) = 0
Else
  SupAss(t) = SupAss(t) − Liab(t)
  Liab(t) = 0
EndIf
EndIf
TotAss(t) = OthAss(t) − OthLiab(t) + SupAss(t) − SupLiab(t) + HomeAss(t)
              − HomeLiab(t) − Liab(t)
$If \frac{TotAss ( t )}{CPIInd ( t )} > TargetLegacy Then$
      ShortfallAge = Age(t)
      ShortfallAssets = TotAss(t)/CPIInd(t)
EndIf
$If Age ( t ) = RetAge Then ShortfallAssetsRetAge = \frac{TotAss ( t )}{CPIInd ( t )}$
$If Age ( t ) = TargetSFAge Then ShortfallAssetsTargetSFAge = \frac{TotAss ( t )}{CPIInd ( t )}$
```

8. The electronic calculator of claim 1, wherein the report comprises user input interface for a user to adjust the personal financial data.

9. The electronic calculator of claim 1, wherein the report is adapted to display all the assets allocation by the retirement income.

10. The electronic calculator of claim 1, wherein the report comprises a graph showing a set of simulated investment strategies according to risks and retirement income.

11. The electronic calculator of claim 1 further comprises a display and an input device.

12. The electronic calculator of claim 11 wherein the input device is a touch screen.

13. The electronic calculator of claim 1, further comprises a communication module for connecting to a network through a network protocol such as Ethernet, Wi-Fi™ or Blue Tooth™.

14. The electronic calculator of claim 1, wherein connection to the remote server is carried out through an application programming interface.

15. The electronic calculator of any of claim 14, wherein the application programming interface is provided through Amazon Web Services™.

16. The electronic calculator of claim 1 comprises a handheld sized body.

17. The electronic calculator of claim 1 comprising:
a computer terminal having one or more central processing units, and memory unit;
an I/O interface connecting to one or more input device, and output devices,
a network interface module.

18. A computing process comprising the steps of:
receiving personal financial data from a user;
connecting to a database and retrieving simulation data; wherein the simulation data is integrated with the personal financial data to set up the current and future assets and cash flow data;
generating a set of assets for allocation;
connecting to a remote server, and forwarding at least part of current and future assets and cash flow data, simulation data, and the set of assets for allocations to carry out the steps of:
for each iteration of an asset in the set of assets for allocation, carry out the following simulations to generate a retirement income and risk percentile associated:
(i) calculate minimum drawdown, age pension and tax for each year;
(ii) calculating assets and liabilities at the end of a year, and
(iii) determine whether the net assets is less than legacy and age is greater than a target age
retrieving a selected risk percentile from the personal financial data;
sorting assets allocation by the retirement income;
selecting optimal asset allocation; and
generating and displaying a report with the optimal asset allocation.

19. An electronic, electromagnetic or optic media carrying the machine codes for carrying out the process of claim 18 on an electronic calculator.

20. An electronic, electromagnetic or optic media carrying the machine codes for carrying out the process of claim 18 on a computer terminal.
